(19) United States
(12) Patent Application Publication
(10) Pub. No.: US 2016/0089307 A1
(43) Pub. Date: Mar. 31, 2016

(54) AUXILIARY BOTTLE FEEDING APPARATUS AND BABY PRODUCT TO WHICH AUXILIARY BOTTLE FEEDING APPARATUS IS MOUNTED

(71) Applicant: Eun-yeong OH, Busan (KR)

(72) Inventor: Eun-yeong OH, Busan (KR)

(21) Appl. No.: 14/890,907

(22) PCT Filed: May 9, 2014
(86) PCT No.: PCT/KR2014/004195

§ 371 Date: Nov. 12, 2015

(30) Foreign Application Priority Data
May 12, 2013 (KR) 10-2013-0053496
Nov. 11, 2013 (KR) 10-2013-0136119

(51) Int. Cl. A61J 9/06; A63H 33/00; A47D 13/02

(52) U.S. Cl. CPC A61J 9/0661; A61J 9/0638; A61J 9/0692; A47D 13/025; A63H 33/006

(57) ABSTRACT

The present invention relates to a baby product, and more particularly to an auxiliary bottle feeding apparatus and a baby product to which the auxiliary bottle feeding apparatus is mounted, which are conceived to perform bottle feeding even without assistance of a guardian while taking care of a baby, and serve as a means for making the face of a baby seated in a bottle feeding posture on the baby product and a pacifier of a baby bottle located on a space to face each other while being spaced apart from each other by a predetermined interval, and consistently fixing said state at the same time.

### BACKGROUND

(a) Technical Field

The present invention relates to various baby products which can be used as an auxiliary product in the procedure of taking care of a baby, and relates to an auxiliary bottle feeding apparatus which is a means for mounting a baby bottle on the baby product at the time of bottle feeding of the milk or baby food and a baby product to which the auxiliary bottle feeding apparatus is mounted which is manufactured by mounting the auxiliary bottle feeding apparatus.

The present invention relates to the baby product, and more particularly, to the auxiliary bottle feeding apparatus which is an auxiliary means which makes the bottle feeding very easily carried out without borrowing the hands of the bottle feeder in case of bottle feeding a prepared food or bottle feeding by using the baby bottle even when feeding the breast milk, or without any restriction in a condition in which the bottle feeder is moving in a space or performs daily routine works, and the baby product to which the auxiliary bottle feeding apparatus is mounted.

(b) Background Art

The conventional technology related to the technology of the present invention is a stand type.

However, this known auxiliary bottle feeding apparatus of movable type has a disadvantage in that it should be moved together with the baby at the time of bottle feeding and that it occupies a certain space for deposition as an dependent body, acts as an impediment element in view of the beauty according to the exposure to the outside, and has disadvantage in view of danger of damage according to normal exposure and various disadvantages as to administration.

In the meantime, the baby product to which the auxiliary bottle feeding apparatus of the present invention is mounted is more concretely constituted by comprising a baby carrier, baby hip sack, baby transportation waist sack, baby sofa, baby chair, baby auxiliary chair, baby bottle feeding cushion, car safety seat for baby, baby carrier, baby bed, baby rocking bed, baby walker, and the conventional technology related to the present invention can in contrast include for example a baby carrier, baby sofa, baby bottle feeding dedicated cushion, baby bed, baby safety seat, baby auxiliary char, baby carriage.

However, since any apparatus for helping the bottle feeding of the baby is not provided at the conventional technology, many inconveniences such as the limitation on the activity of the bottle feeder at the time of bottle feeding, pain on the human body, limitation on the use of the time, and limitation on the movement in space.

### SUMMARY OF THE DISCLOSURE

Therefore, the present invention has been made in an effort to solve various problems caused due to longtime bottle feeding repeated every day in the process of taking care of baby, and the purpose of the present invention is to provide a baby product of novel structure obtained by combining on the baby product a means designed so as to remove the limitation on the use of the time and limitation on the movement and the pain on various parts of body due to the fixed bottle feeding posture so that the daily life pattern which the mother enjoyed before the birth can be done without change.

Accordingly, the present invention provides a baby product to which the auxiliary bottle feeding apparatus is mounted, which are conceived to perform bottle feeding even without assistance of a guardian while taking care of a baby, and serve as a means for making the face of a baby seated in a bottle feeding posture on the baby product and a pacifier of a baby bottle located on a space to face each other while being spaced apart from each other by a predetermined interval, and consistently fixing said state at the same time.

### EFFECT OF THE PRESENT INVENTION

The auxiliary bottle feeding apparatus and the baby product to which the auxiliary bottle feeding apparatus is mounted according to the present invention provides an effect of making the daily life pattern which the mother enjoyed before the birth capable of being done without change.

The auxiliary bottle feeding apparatus and the baby product to which the auxiliary bottle feeding apparatus is mounted according to the present invention provides an effect of preventing all physical pains including shoulder pain, back pain, leg pain, waist pain, etc. occurring according to the suppression of the mother to the fixed bottle feeding posture.

The auxiliary bottle feeding apparatus and the baby product to which the auxiliary bottle feeding apparatus is mounted according to the present invention provides an effect of preventing the home activity capability degrade, business performance capability degrade, mental tired feeling, etc. due to the lack of sleep of the mother due to the bottle feeding during the sleeping.

The auxiliary bottle feeding apparatus and the baby product to which the auxiliary bottle feeding apparatus is mounted according to the present invention provides, in particular, in case of the car safety sheet of the baby, an effect of preventing the danger of the accident due to the release of the safety belt since the bottle feeding is possible independently without the help of the mother in case where the bottle feeding is necessary during the drive, and also of preventing the inconveniences of stopping the driving of the car for the bottle feeding in case where only the mother and the baby are on the car.

The auxiliary bottle feeding apparatus and the baby product to which the auxiliary bottle feeding apparatus is mounted according to the present invention provides, in particular, in case of the baby carriage or baby carrier, an effect of not limiting all daily activities performed at the time of going outside such as dining, enjoying the coffee, receiving the telephone, shopping, etc. since the bottle feeding is very easy and the mother can be free even in case of going outside together with the baby since the bottle feeding is possible in the condition in which the baby bottle is mounted on the auxiliary bottle feeding apparatus mounted on the baby product and the baby is seated on the baby product, and also of reducing the economic expenditure since it is not necessary to move to a certain place for bottle feeding since it is possible to bottle feed by mounting the baby bottle on the auxiliary bottle feeding apparatus mounted during the movement by walking while seating the baby on the baby carriage.

The auxiliary bottle feeding apparatus and the baby product to which the auxiliary bottle feeding apparatus is mounted according to the present invention provides, in particular, in case of the baby mattress (or baby bed), an effect of enabling the business, home activities, hobby activities, etc. during the bottle feeding time and also of preventing the cause of the body pain since the body movement is not limited since the bottle feeding can be done in the condition in which the baby bottle is mounted on the auxiliary bottle feeding apparatus mounted on the baby mattress and the baby is laid down.

The auxiliary bottle feeding apparatus and the baby product to which the auxiliary bottle feeding apparatus is mounted according to the present invention provides, in particular, an effect of preventing the stress due to the lack of sleeping since the sleeping of the mother is not interrupted by the bottle feeding during the sleeping time, and of preventing various losses such as the physical strength degrade, business performance capability degrade, home activity capability degrade, health degrade, etc. due to the stress.

The auxiliary bottle feeding apparatus and the baby product to which the auxiliary bottle feeding apparatus is mounted according to the present invention provides, in particular, in case of the baby sofa (or baby chair), an effect of enabling the business, home activities, hobby activities, etc. during the bottle feeding time and also of preventing the cause of the body pain since the body movement is free since the bottle feeding can be done in the condition in which the baby bottle is mounted on the auxiliary bottle feeding apparatus mounted on the baby sofa and the baby is seated, and of enabling the visual confirmation of the safety of baby and at the same time the performance of the work (business, home activities, hobby activities, etc.) by freely moving the sofa (or chair) so that the baby is in the sight of the mother.

The auxiliary bottle feeding apparatus and the baby product to which the auxiliary bottle feeding apparatus is mounted according to the present invention provides, in particular, in case of the baby carriage, of reducing the economic expenditure since it is not necessary to move to a certain place for bottle feeding even during the movement by the baby carriage since the bottle feeding is possible in the condition in which the baby bottle is mounted on the auxiliary bottle feeding apparatus mounted on the baby carriage and the baby is seated, and also of freeing the activities of the mother since the help of the mother is not required.

The auxiliary bottle feeding apparatus and the baby product to which the auxiliary bottle feeding apparatus is mounted according to the present invention provides an effect of removing the inconveniences of having to move the auxiliary bottle feeding apparatus at the time of bottle feeding since the auxiliary bottle feeding apparatus is mounted on each baby product.

The auxiliary bottle feeding apparatus and the baby product to which the auxiliary bottle feeding apparatus is mounted according to the present invention provides an effect of maintaining the appearance simple, raising the durability of the auxiliary bottle feeding apparatus, and preventing the injury of the baby since the auxiliary bottle feeding apparatus can be built-in in the baby product so that the apparatus is not exposed to the outside.

The auxiliary bottle feeding apparatus and the baby product to which the auxiliary bottle feeding apparatus is mounted according to the present invention provides an effect of enabling the continuous use of the baby product even in case where the baby is grown and the bottle feeding through the auxiliary bottle feeding apparatus is no more required since the auxiliary bottle feeding apparatus can be concealed in the baby product and be deposited so that the auxiliary bottle feeding apparatus is not exposed.

The auxiliary bottle feeding apparatus and the baby product to which the auxiliary bottle feeding apparatus is mounted according to the present invention provides an effect of making the bottle feeding very easy since all of the constituting elements on the auxiliary bottle feeding apparatus are operated similar to the operation of the mom's hands.

### BRIEF DESCRIPTION OF THE DRAWINGS

FIG. 1 is an embodiment of an auxiliary bottle feeding apparatus according to the present invention including a bottle fix section 1-10 and an arm section 1-20 as main constituting elements,

FIG. 2 is an embodiment of an auxiliary bottle feeding apparatus according to the present invention having a structure including a bottle fix means inclination adjustment means 10-5,

FIG. 3 is an embodiment of an auxiliary bottle feeding apparatus according to the present invention having a structure including a bottle fix means inclination adjustment means on a horizontal arm,

FIG. 4 is an embodiment of an auxiliary bottle feeding apparatus according to the present invention structured by combining a bottle holder and the horizontal arm by using a screw type connection means 10-11,

FIG. 5 is an embodiment of an auxiliary bottle feeding apparatus according to the present invention structured by combining the bottle holder and the horizontal arm by using a bottle fix means fix shaft 10-6,

FIG. 6 is an embodiment of an auxiliary bottle feeding apparatus according to the present invention having a structure including a bottle fix means fix stand 10-2,

FIG. 7 is an embodiment of an auxiliary bottle feeding apparatus according to the present invention having a structure including a bottle fix means height adjustment means 10-9 including a height adjustment shaft 20-9-1, a fix means 20-9-2, and an inlet space 20-9-3 as main constituting elements,

FIG. 8 is an embodiment of an auxiliary bottle feeding apparatus according to the present invention having a structure including an auxiliary bottle feeding apparatus vertical inclination adjustment means 20-1-1,

FIG. 9 shows an arm section retraction means 20-8 and is an embodiment of an auxiliary bottle feeding apparatus according to the present invention having a structure including a rotary connection means as a connection means of the horizontal arm and the vertical arm,

FIG. 10 is an embodiment of an auxiliary bottle feeding apparatus according to the present invention having a structure in which an injury prevention auxiliary arm 20-3 having as a constituting element a horizontal arm 20-2 having a structure including an outer cylinder 20-10, the injury prevention auxiliary arm (=inner cylinder) 20-3, and a latch means 20-3-1 is mounted,

FIG. 11 is an embodiment of an auxiliary bottle feeding apparatus according to the present invention having a structure including an auxiliary bottle feeding apparatus height adjustment means 20-5 having as a constituting element a vertical arm 20-1 including an outer cylinder 20-11, a height adjustment arm (=inner cylinder) 20-5-1, and a height adjustment arm fix means 20-5-2 as constituting elements,

FIG. 12 is an embodiment of an auxiliary bottle feeding apparatus according to the present invention having a structure including an auxiliary bottle feeding apparatus horizontal rotation means 20-6 constituted as a rotary connection means,

FIG. 13 is an embodiment of an auxiliary bottle feeding apparatus according to the present invention having a structure including an auxiliary bottle feeding apparatus reception means (case) 2 which is an container housing the entire or part of the auxiliary bottle feeding apparatus 1 of all structures described above,

FIG. 14 shows sequence of use of the auxiliary bottle feeding apparatus,

FIG. 15 shows a mattress for a baby according to the present invention to which the auxiliary bottle feeding apparatus 1 is mounted,

FIG. 16 shows a mattress for a baby according to the present invention to which a back rest angle adjustment means 9 is mounted,

FIG. 17 is a detailed drawing of “the mattress for a baby C to the front lower end of which the auxiliary bottle feeding apparatus is mounted” described through FIG. 15,

FIG. 18 is a drawing of use of the mattress for a baby,

FIG. 19 shows the mattress for a baby having an arm 1-20 of the form of archery,

FIG. 20 is an embodiment of <a bed for a baby>,

FIG. 21 is an embodiment of <a car safety seat for a baby>,

FIG. 22 is an embodiment of <a baby carriage>,

FIG. 23 is an embodiment of <a carrier for a baby>,

FIG. 24 is an embodiment of <a cradle for bottle feeding>,

FIG. 25 is an embodiment of <a sofa for a baby>,

FIG. 26 shows various embodiments of the arm 1-20 of the auxiliary bottle feeding apparatus 1,

FIG. 27 is an embodiment of change of the bottle holder,

A of FIG. 28 is an embodiment of a structure including a seating seat 40, a forward safety guard 42, and a rearward safety guard 44,

B is a baby carrier of a structure including as main constitutional elements the seating seat 40, the forward safety guard 42, a side safety guard 43, the rearward safety guard 44, and an auxiliary bottle feeding apparatus 1, and in particular, an embodiment of a structure in which the arm 1-20 of the form of an archery is mounted at the side of the rearward safety guard 44 of the baby carrier,

FIG. 29 is a side elevation drawing of the baby carrier in which the auxiliary bottle feeding apparatus 1 according to the present invention is mounted,

FIG. 30 shows the baby carrier having a structure in which the auxiliary bottle feeding apparatus reception space 4 is formed at the rear of the seating seat 40,

FIG. 31 is an embodiment of a structure in which a combination means 41-1 of a shoulder traction string 41 is formed at the bottom of the seating seat 40,

FIG. 32 shows an embodiment of the baby carrier according to the present invention having a structure including an overturn prevention support stand 46,

FIG. 33 shows the baby carrier including as constitutional elements the seating seat 40, the shoulder traction string 41, and the forward safety guard 42,

FIG. 34 shows the baby carrier having a structure including the seating seat 40, the shoulder traction string 41, the forward safety guard 42, a vest type safety guard 45, and the auxiliary bottle feeding apparatus 1, and

FIG. 35 is an embodiment of the baby carrier manufactured using resin expanded beads of more than two color tones as raw material.

### DETAILED DESCRIPTION

The present invention relates to a baby product, and more particularly to an auxiliary bottle feeding apparatus and a baby product to which the auxiliary bottle feeding apparatus is mounted, which are conceived to perform bottle feeding even without assistance of a guardian while taking care of a baby, and serve as a means for making the face of a baby seated in a bottle feeding posture on the baby product and a pacifier of a baby bottle located on a space to face each other while being spaced apart from each other by a predetermined interval, and consistently fixing said state at the same time.

In more detail, the present invention relates to an auxiliary bottle feeding apparatus and a baby product to which the auxiliary bottle feeding apparatus is mounted, comprising:

a bottle fix section for fixing the baby bottle by being combined to a combination means which is a constituting element additionally constituted on the baby bottle for the purpose of wrapping the entire or part of the bottle body excluding a pacifier or combining the baby bottle and the auxiliary bottle feeding apparatus;

an arm section being a member of a curved type or a type capable being curved which is constituted by having at least one rectangular member as a constituting element and which can realize the interior angle less than 180 degree; and

a combination means which is formed at one or more ends selected among two ends of the arm section and which is for combining the arm section on the baby product (or an additional constituting element which is constituted for the purpose of mounting the auxiliary bottle feeding apparatus on the baby product),

wherein, in the arm section, the at least one ends selected among the two ends of the arm section which the member of a curved type or a type capable being curved has are connected to selected positions (or an additional constituting element constituted for the mounting of the auxiliary bottle feeding apparatus) on the baby product, an extension section of the remaining rod excluding one end to be connected (or an extension section of the remaining rod excluding both ends to be connected) is extended to a space positioned in front of the baby seated in the bottle feeding posture on the baby product and passes without fail a space positioned in front of the face of the baby, and the bottle fix section is connected on the rod passing the front of the face of the baby.

(* Bottle feeding posture: condition in which the baby is seated on the baby product for bottle feeding. Bottle feeding position: the auxiliary bottle feeding apparatus is ready in a condition in which the auxiliary bottle feeding apparatus is completely capable of bottle feeding through the action of erection, development, etc.)

Hereinafter, the detailed structure of the auxiliary bottle feeding apparatus and the baby product to which the auxiliary bottle feeding apparatus is mounted according to the present invention will be described with reference to the accompanying drawings.

First, main structure of the auxiliary bottle feeding apparatus according to the present invention will be described.

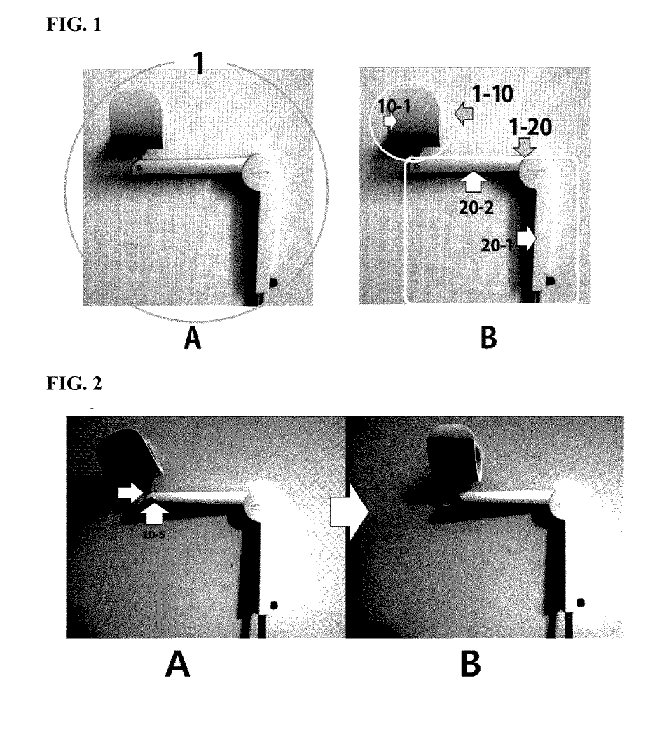

Hereinafter, FIG. 1 will be referred to.

FIG. 1 shows the auxiliary bottle feeding apparatus 1 according to the present invention, which includes a bottle fix section 1-10 and an arm section 1-20 as the main constituting elements.

The bottle fix section 1-10 which is the main constituting element of the auxiliary bottle feeding apparatus according to the present invention includes a bottle fix means 10-1 as the main constituting element, and is a constituting element for holding the body of the baby bottle so as to be able to fix the baby bottle on the arm section 1-20.

In the meantime, the bottle fix means 10-1 can be made in 1) a form obtained by transforming a part of a horizontal arm 20-2 into a bottle fix means of the desired form, or 2) a form obtained by combining the bottle fix means manufactured in a desired form through an independent process to a desired point on the horizontal arm by using an additional combination means.

In addition, the bottle fix means 10-1 can be made with 1) a structure in a form of wrapping the entire or part of the bottle body, or 2) a structure (not shown) in a form of mutually combining a combination means additionally formed on the body of the baby bottle for the purpose of fixing the baby bottle and another combination means making a pair with the combination means.

In addition, the bottle fix means can include as a preferred embodiment a bottle holder (* hereinafter, referred to as 1-10) of the form shown in FIG. 1 as an embodiment of the “a structure of wrapping the entire or part of the bottle body”.

Hereinbefore, the main constituting elements of the bottle fix means 10-1 have been described.

Hereinafter, the main constituting elements of the arm 1-20 will be described.

The arm section of FIG. 1 is made by including the horizontal arm 20-2 and a vertical arm 20-1, and in particular, shows an arm section of the shape of [symbol] .

The horizontal arm is an arm crossing the face of the baby in the bottle feeding posture, and is a constituting element where at a selected position the bottle fix section is mounted.

In addition, the vertical arm means an arm which is fixed on the baby product by being curved into a condition of making an interior angle of less than 180 degree with the horizontal arm. Therefore, the “horizontal” and the “vertical” are not necessarily interpreted to be related to the ground surface in the present invention.

In addition, the horizontal arm 20-2 and the vertical arm 20-1 can be divided into two aspects according to the form on the members constituting them, and the aspects include 1) a structure of concurrently forming the horizontal arm and the vertical arm by using one member curved to a predetermined angle, and 2) a structure of mutually connecting two rectangular members by using a combination means.

In addition, in the embodiment of 1) which is the former one among the above two aspects, for example, a jabara type member, cobra type member, resin molded member, wood molded member, and wire curved member can be included, and in the present structure, the classification of the vertical arm 20-1 and the horizontal arm 20-2 is judged in a condition where the auxiliary bottle feeding apparatus 1 is completely developed to the bottle feeding posture, and at this time, a section to which an extension section of the rod of the arm which passes a spacing on the front of the face of the baby in the bottle feeding posture is included can be classified into the horizontal arm, and the extension section of the arm excluding the above said section can be classified into the vertical arm.

In addition, the interior angle which the vertical arm 20-1 and the horizontal arm 20-2 consist in the bottle feeding position is not necessarily the right angle as in FIG. 1, and can suffice by being a maximum less than 180 degree.

In the meantime, in case where the arm section in the above description is consisted of one rectangular member, the shape of the member can be consisted of one structure selected among the resin molded part, wood molded part, metal wire curved molded part, jabara type member, and cobra type member.

In addition, in case where the arm section is consisted by the combination of two or more rectangular members, the combination method of the members can be one of combination types such as a rotary retraction type, facing retraction type, slide retraction type, drawing in retraction type, and articulation rotary retraction type, or can be the method into which two or more combination types are merged, or can be the method in which one selected among the rotary retraction type, facing retraction type, slide retraction type, drawing in retraction type and articulation rotary retraction type and one selected among the jabara type and cobra type are merged.

Hereinafter, the arm section according to the present invention including the structure of FIG. 1 described above will be described once again through virtual embodiments.

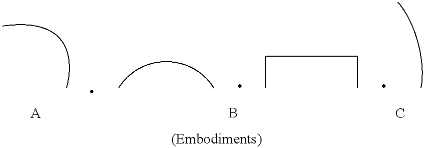

(* the part of displaying green color represents an end portion which is fixed on the baby product)

The arm section of A type, B type, and C type embodiment is consisted by one or two or more rectangular members as the consisting elements.

These can be more concretely described as follows:

<In Case where the Structures of a Type, B Type, and C Type have One Rectangular Member as the Consisting Element>

A Type)

* Structure in which one end of the arm section 1-20 can be fixed at a selected predetermined place on the baby product (or auxiliary bottle feeding apparatus reception means or auxiliary bottle feeding apparatus reception space) and the bottle fix section 1-10 can be mounted on the other end (horizontal arm 20-2). (a of A, a of B, a and b of E of FIG. 2)

B Type)

Structure in which the arm section crosses in left and right direction the body of the baby seated in the bottle feeding posture on the baby product, and both ends of the arm section can be fixed on the baby product, and the bottle fix section can be mounted on a place (horizontal arm) facing the position of the mouth of the baby on the arm section rod.

(a˜f of D of FIG. 2)

C Type)

Structure in which one end of the arm section can be erected to be fixed in the direction perpendicular to the ground surface at the front of the body of the baby seated in the bottle feeding posture on the baby product, and the bottle fix section can be mounted on the other end.

Furthermore, a structure in which the entire of the arm section is consisted in a cobra type arm can be included as a preferred example, and in addition, a molded part which is molded as a unit of A type, B type and C type and a structure in which the metal wire is curved can also be included as preferred examples.

In addition, <in case where the structures of A type, B type, and C type has two or more rectangular members as the consisting elements>

This means that two or more rectangular members represent one shape among the structures of A type, B type and C type as a whole under a condition where the members are combined and developed into the bottle feeding position.

That is, A type) Structure in which one end of the arm section can be fixed at a selected predetermined place on the baby product (or auxiliary bottle feeding apparatus reception means or auxiliary bottle feeding apparatus reception space) under the condition where the arm section is developed into the bottle feeding position and the bottle fix section can be mounted on the other end (horizontal arm).

B type) Structure in which the arm section crosses in left and right direction the body of the baby seated in the bottle feeding posture on the baby product under the condition where the arm section is developed into the bottle feeding position, and both ends of the arm section can be fixed on the baby product, and the bottle fix section can be mounted on a place (horizontal arm) facing the face of the baby from the rod which extends the arm section.

C type) Structure in which the arm section can be erected to be fixed in the direction perpendicular to the seating surface of the baby at the front of the body of the baby seated in the bottle feeding posture on the baby product under the condition where the arm section is developed into the bottle feeding position, and the bottle fix section can be mounted on the other end.

Furthermore, the combination method of the members consisting the arm section can be one of combination types such as a rotary retraction type, facing retraction type, slide retraction type, drawing in retraction type, and articulation rotary retraction type, or can be the method into which two or more combination types are merged.

In addition, at one or more end selected among both ends of the arm section which has been completed to be combined as described above, a combination apparatus to combine the auxiliary bottle feeding apparatus and the baby product, or the auxiliary bottle feeding apparatus and the auxiliary bottle feeding apparatus reception means or auxiliary bottle feeding apparatus reception space is additionally consisted.

(* the auxiliary bottle feeding apparatus reception means, auxiliary bottle feeding apparatus reception space: refer to below description)

The above description will be described in detail once again.

The structure of the arm section corresponds, under a condition where the auxiliary bottle feeding apparatus is developed into the bottle feeding position, to one structure selected among the following structures:

1) Structure in which one end of the arm section is connected at a selected predetermined place on the baby product (surface of the baby product or auxiliary bottle feeding apparatus reception means or auxiliary bottle feeding apparatus reception space) placed at one position selected among left, right, front, between two legs, above the head of the baby seated in the bottle feeding posture, and the bottle fix section is mounted on the other end (horizontal arm).

2) Structure in which both ends of the arm section which crosses in left and right direction the space placed in front of the body of the baby seated in the bottle feeding posture are respectively connected to the selected constituting element on the baby product placed at the left and right of the baby product, and the bottle fix section is mounted on a place placed at the front of the face of the baby from the rod which extends the arm section.

3) Structure in which one end of the arm section is connected, in the direction perpendicular to the surface to which the hips of the baby is seated, to the selected constituting element on the baby product placed on the front of the body of the baby seated in the bottle feeding posture, and the bottle fix section is mounted on the other end.

Up to now, the main structure of the bottle fix section 1-10 and the arm section 1-20 according to the present invention has been described through FIG. 1.

Hereinafter, additional constituting elements of the bottle fix section 1-10 and the arm section 1-20 will be described through FIGS. 2 to 13.

The bottle fix section 1-10 which is a main constituting element according to the present invention can be consisted through a structure which additionally includes one or more constituting elements selected among a bottle fix means fix stand 10-2, bottle fix means inclination adjustment means 10-5, bottle fix means fix shaft 10-6, bottle fix means horizontal rotation means 10-7, bottle fix means advance and retreat means 10-8, and bottle fix means height adjustment means 10-9.

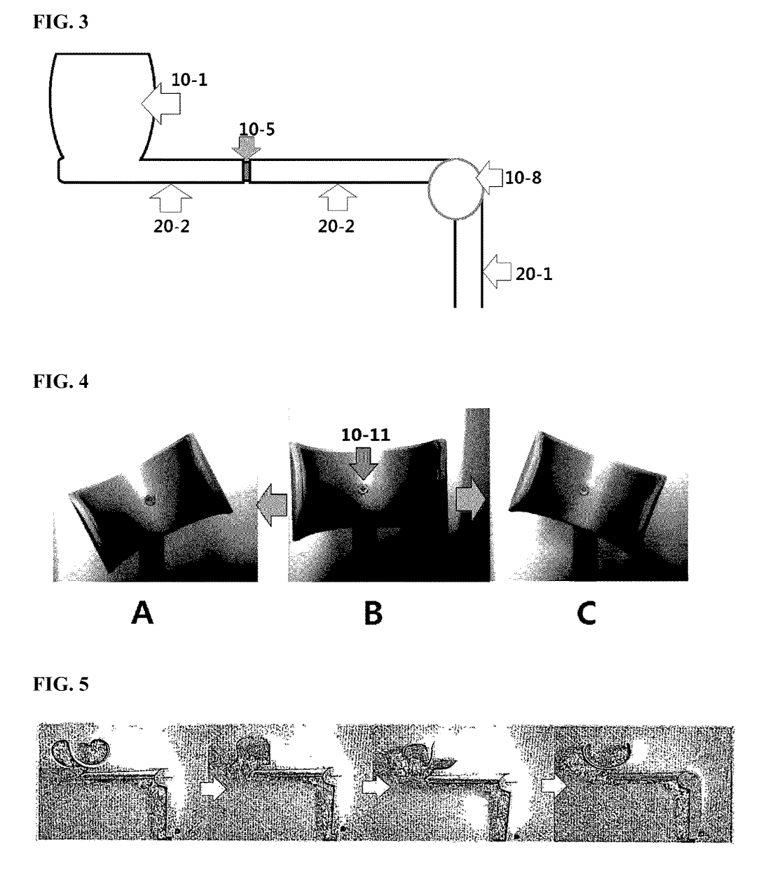

Hereinafter, FIGS. 2 and 3 will be referred to.

The bottle fix means inclination adjustment means 10-5 is a constituting element for changing the vertical angle of the bottle holder 10-1.

FIG. 2 shows an embodiment of the bottle fix means inclination adjustment means 10-5 in which the bottle holder 10-1 is perpendicular to the horizontal arm 20-2, and the bottle fix means fix shaft 10-6 formed at a lower end of the bottle holder 10-1 can be inserted into a recess formed at an end of the horizontal arm 20-2 and can be mutually connected by means of screw type combination means.

In addition, the screw type combination method maintains a loose combination of the bottle fix means fix shaft 10-6 so that the bottle holder 10-1 can be rotated in desired direction as shown in the left and right side of the drawing.

(* For the detailed description of the bottle fix means fix shaft 10-6, refer to the contents below. * Loose combination condition: two or more constituting elements are not mutually attached but combined while being separated)

FIG. 3 is another embodiment of the bottle fix means inclination adjustment means 10-5 in which the bottle holder 10-1 is horizontally connected to the extension line of the horizontal arm 20-2, and can include 1) a structure in which one side of the bottle holder 10-1 and one side of the horizontal arm 20-2 separately manufactured through independent processes are mutually connected and loose combined by using the screw type combination means and 2) a structure in which a selected one constituting element among the horizontal arm 20-2 and the bottle holder 10-1 is inserted into inside space of the remaining constituting element and loose combined.

For example, the latter means that it can include, as a preferred example, a structure in which the horizontal arm 20-2 and the bottle holder 10-1 are manufactured in a draw in type structure of respectively inner cylinder and outer cylinder and are mutually combined.

In addition, a method in which the horizontal arm 20-2 is divided into two parts and a rotary connection arm 10-5 is inserted and combined between the two parts as shown in FIG. 3 can be included as another embodiment of the bottle fix means inclination adjustment means 10-5.

However, all the above mentioned embodiments are only the embodiments for describing the structure of the present invention and do not limit the present invention.

Hereinafter, FIGS. 4 and 5 will be referred to.

The bottle fix means horizontal rotation means 10-7 is a constituting element for changing the horizontal angle of the bottle holder 10-1.

FIG. 4 shows an embodiment in which the bottle holder and the horizontal arm are loose combined by using a screw type connection means 10-11.

In addition, FIG. 5 shows, along the progress of the arrows, a state where the bottle holder 10-1 is freely rotated through the bottle fix means horizontal rotation means 10-7, and is an embodiment in which the bottle holder and the horizontal arm are loose combined by using the bottle fix means fix shaft 10-6.

(* The bottle fix means fix shaft: connection apparatus for combining the bottle holder and the horizontal arm so that a predetermined spacing is formed between them.)

The bottle fix means horizontal rotation means 10-7 of the above said structure, in case where the head of the baby is moved left and right while bottle feeding, makes the bottle move together with the bottle in the same direction as that of the movement of the head so as to provide an advantage of preventing the phenomenon of escape of the pacifier from the mouth while bottle feeding.

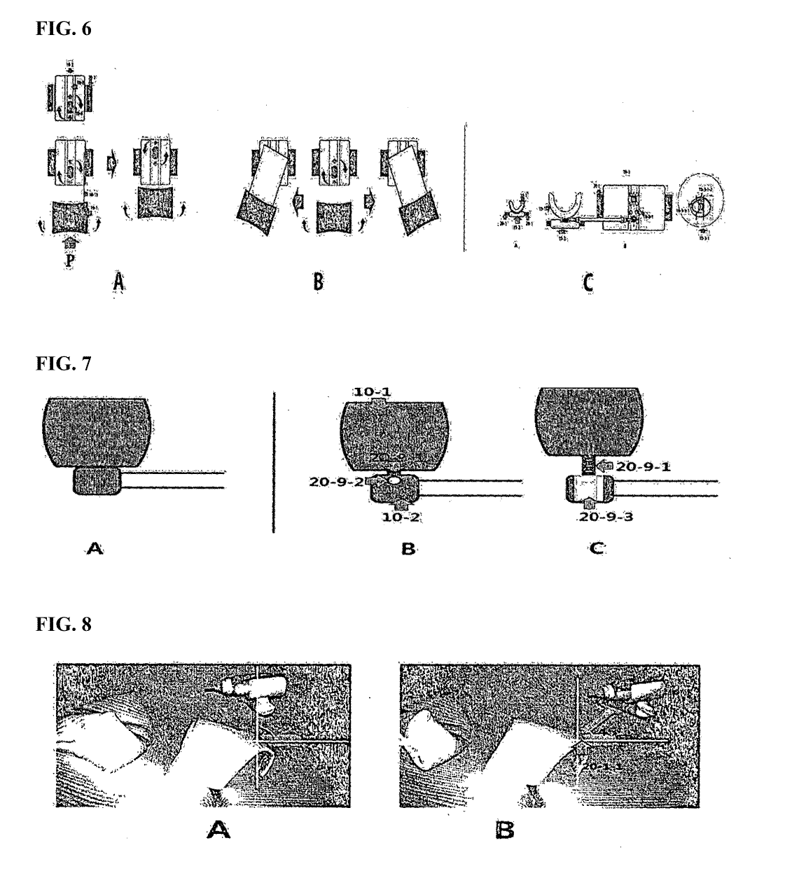

(As another embodiment, FIG. 6 will be referred to which will be described below.)

The bottle fix means fix shaft 10-6 is a means for connecting the bottle holder 10-1 and the bottle fix means fix stand 10-2, and is a constituting element which can be effectively used in case of additionally adding a vertical angle adjustment function, horizontal rotation function, advance and retreat function, etc. to the bottle holder 10-2.

In addition, the bottle fix means fix shaft 10-6 is a constituting element which is connected to the bottom of the bottle holder 10-1 and has a predetermined length, and has a structure selected among integral type with the bottle holder 10-2 or assembly type.

In addition, one end of the bottle fix means fix shaft 10-6 is connected to the bottom of the bottle holder 10-1, and the other end is connected to the horizontal arm 20-2 or the bottle fix means fix stand 10-2 (refer to FIGS. 1 and 5).

In addition, the connection method can be freely selected among the loose combination method and the integral combination method. (* loose combination method: two or more constituting elements are not mutually attached but combined while being separated. * integral combination method: two or more constituting elements are connected in the condition of being mutually attached by mutually attaching the two or more constituting elements or integrally manufacturing them when molding them.)

In the meantime, the loose combination method can be a preferred structure by making the bottle fix means fix shaft 10-6 to be able to act in various directions, and in conclusion, by granting various action functions to the bottle holder 10-1. (For detailed description about the action functions, refer to a bottle holder inclination adjustment function, bottle holder horizontal rotation function, bottle holder advance and retreat function, etc.)

Hereinafter, FIG. 6 will be referred to.

The bottle fix means fix stand 10-2 is a pedestal of the bottle holder 10-1, and is a constituting element which can be added in case of granting various functions to the bottle holder 10-1.

In addition, the bottle fix means fix stand 10-2 is placed in a space at the back of the bottle holder 10-1, and in particular, is formed at the connection section of the bottle holder 10-1 and the horizontal arm 20-2 or between the bottle fix means fix shaft and the horizontal arm.

In addition, since the structure of the bottle fix means fix stand 10-2 can be more or less complicated in case of concurrently granting various functions including the inclination adjustment function, horizontal rotation function, advance and retreat function, etc. to the bottle holder as in the embodiment shown in FIG. 6, it can be more advantageous in view of the process to manufacture through independent process and connect it to the horizontal arm 20-2. However, the horizontal arm 20-2 can be manufactured to be able to perform the above functions by changing a part of the design of the horizontal arm 20-2, and in this case, the bottle fix means fix stand 10-2 can be omitted.

In the meantime, A, B, and C of FIG. 6 show as embodiments of the above said structure the bottle fix means fix stand 10-2 on which the bottle fix means horizontal rotation means 10-7 and the bottle fix means advance and retreat means 10-8 are mounted. That is, describing in more detail, FIG. 6 which is an embodiment shows the bottle fix section 1-10, wherein a rail 10-3 is formed on the bottle fix means fix stand 10-2, and on the rail 10-3, the bottle holder 10-1 to which a spacing formation section 10-10 is additionally formed is loose fixed on the road of the rail 10-3 while being combined with the bottle fix means fix shaft 10-6, whereby the bottle holder can have the horizontal rotation function and the advance and retreat function.

In the meantime, the spacing formation section 10-10 is a spacing formation means constituted by extending the rear part of the bottle holder 10-1. This spacing formation section 10-10 provides an advantage of enlarging the spacing between the bottle fix section 1-10 and the baby so that the baby does not collide with the bottle fix section 1-10 when the bottle and the baby collide.

A of the present FIG. 6 shows that the bottle holder 10-1 according to the above said structure is advanced and retreated by actuating the bottle fix means fix shaft 10-6 by a force P applied from the front surface.

(* If the impact P is applied, the bottle holder is retreated as in the right side drawing of A. In addition, if the impact is removed, the bottle holder is advanced in the forward direction so as to be returned to its original position.)

B shows that the bottle holder 10-1 according to the above said structure is rotated left and right by actuating the bottle fix means fix shaft 10-6 by a force P applied from the side surface.

In addition, if the impact is removed, the bottle holder is returned to its original position.

C shows an embodiment of further forming a latch means 10-3-1 and a restoration means 10-3-1-1 on the rail 10-3 according to the above said structure.

The latch means 10-3-1 performs a function of restraining so that the advance and retreat of the bottle fix means fix shaft 10-6 is stepwise achieved in a predetermined section, however, this is different from the above said A and B in that this requires more or less stronger force than A and B, however, the entire function of this can be regarded to be identical.

The restoration means 10-3-1-1 grants the restoration force to the latch means 10-3-1, and is a constituting element making the latch means 10-3-1 to return to its original position after the movement of the bottle fix means fix shaft 10-6. As an example of it, a spring is shown.

The leftmost of C shows an embodiment in which the bottle fix means fix stand 10-2 and the bottle holder 10-1 are connected while the bottle fix means fix shaft 10-6 is omitted.

Hereinafter, FIG. 7 will be referred to.

FIG. 7 shows an embodiment of the bottle fix means height adjustment means 10-9 which includes a height adjustment shaft 20-9-1, fix means 20-9-2, and draw in space 20-9-3 as constituting elements.

A of FIG. 7 shows the auxiliary bottle feeding apparatus from which the bottle fix means height adjustment means 10-9 is omitted.

B and C shows the auxiliary bottle feeding apparatus including the bottle fix means height adjustment means 10-9 according to the present structure.

The height adjustment shaft 20-9-1 is a member having a predetermined length by being connected from the bottom of the bottle holder 10-1 and being extended to the outside, and is loose combined in the draw in space 20-9-3 formed on the bottle fix means fix stand 10-2, and adjusts the height of the bottle through the action of being drawing in and drawing out the above said space. In addition, the height adjustment shaft 20-9-1 is, after the height is set, is fixed to the set height by the fix means 20-9-2.

Hereinbefore, the additional constituting elements of the bottle fix section 1-10 are described.

Hereinafter, additional constituting elements of the arm section 1-20 will be described.

The arm section 1-20 according to the present invention can be constituted through a structure which additionally includes at least one constituting elements selected among an auxiliary bottle feeding apparatus vertical inclination adjustment means 20-1-1, arm section retraction means 20-8, auxiliary bottle feeding apparatus height adjustment means 20-5, auxiliary bottle feeding apparatus horizontal rotation means 20-6, and injury prevention auxiliary arm 20-3.

Hereinafter, FIG. 8 will be referred to.

FIG. 8 shows the auxiliary bottle feeding apparatus vertical inclination adjustment means 20-1-1.

The auxiliary bottle feeding apparatus vertical inclination adjustment means 20-1-1 has a function of vertically rotating the auxiliary bottle feeding apparatus 1 under the condition of being connected on the baby product, and is a constituting element capable of adjusting the vertical inclination of the auxiliary bottle feeding apparatus 1 while bottle feeding or capable of closely attaching and depositing the auxiliary bottle feeding apparatus on the baby product after the bottle feeding.

A and B of FIG. 8 are the auxiliary bottle feeding apparatus vertical inclination adjustment means 20-1-1 in which a screw type connection means which is a loose combination means is used, and show that the auxiliary bottle feeding apparatus 1 can be developed to different angles according to the degree of rotation of the screw type connection means.

A and B are auxiliary bottle feeding apparatuses which are developed in the condition of respectively making angle of 90 degree and 45 degree with the ground surface.

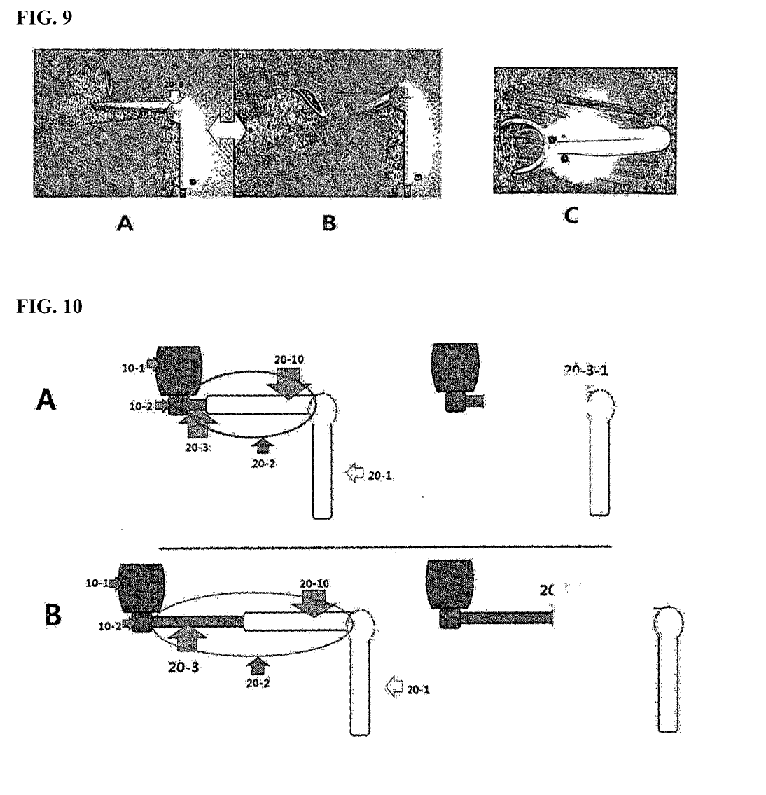

Hereinafter, FIG. 9 will be referred to.

FIG. 9 shows the arm section retraction means 20-8 which is an embodiment in which a rotary connection means is used as the connection means of the horizontal arm and the vertical arm. Of course, a screw type connection means can also be included in preferred embodiments.

The arm section retraction means 20-8 enables the horizontal arm and the vertical arm to be retracted at the time of depositing after the bottle feeding, so that it is a constituting element of making the deposition easy and granting an esthetic sense of appearance by reducing the volume of the auxiliary bottle feeding apparatus 1. A, B, C of FIG. 8 are an embodiment showing the retraction processes.

Hereinafter, FIG. 10 will be referred to.

FIG. 10 shows the auxiliary bottle feeding apparatus 1 to which the injury prevention auxiliary arm 20-3 is mounted which has as a constituting element a horizontal arm 20-2 which includes an outer cylinder 20-10, the injury prevention auxiliary arm (=inner cylinder) 20-3, and latch means 20-3-1.

The injury prevention auxiliary arm 20-3 is a constituting element which extends the function of the bottle fix means advance and retreat means 10-8 described above, and is constituted so that the injury prevention auxiliary arm (=inner cylinder) 20-3 of the structure of loose combined with the outer cylinder can be drawn in and drawn out in the space formed in the horizontal arm 20-2. Therefore, in case where the impact P occurs in front of the injury prevention auxiliary arm 20-3, the injury prevention auxiliary arm 20-3 can be retreated by using the space inside of the outer cylinder so as to prevent injury of the baby.

In addition, the latch means 20-3-1 are formed on the ends the injury prevention auxiliary arm (=inner cylinder) 20-3 and the outer cylinder 20-10, so that the injury prevention auxiliary arm (=inner cylinder) 20-3 is fixed without being completely pulled out to the outside of the outer cylinder. On the other hand, the sections of the inner cylinder and the outer cylinder are preferably constituted to have polygon.

A of FIG. 10 shows a condition in which the injury prevention auxiliary arm (=inner cylinder) 20-3 is drawn into the inside of the outer cylinder 20-10. (a condition in which an impact occurs and the injury prevention auxiliary arm (=inner cylinder) 20-3 is retreated)

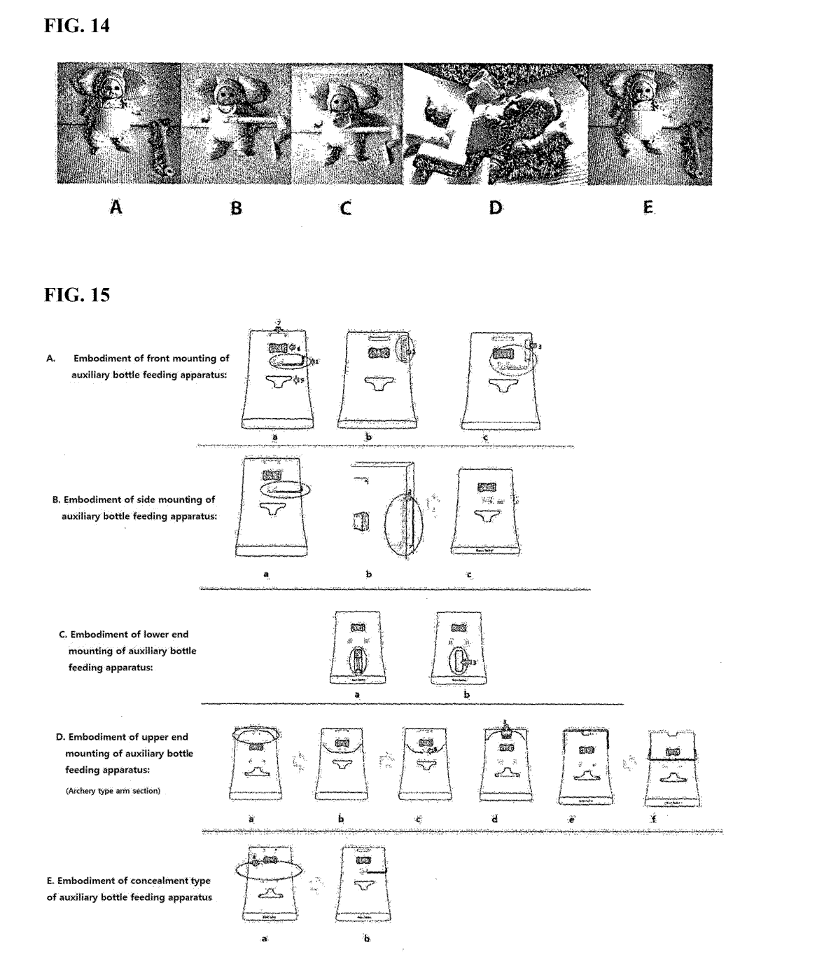

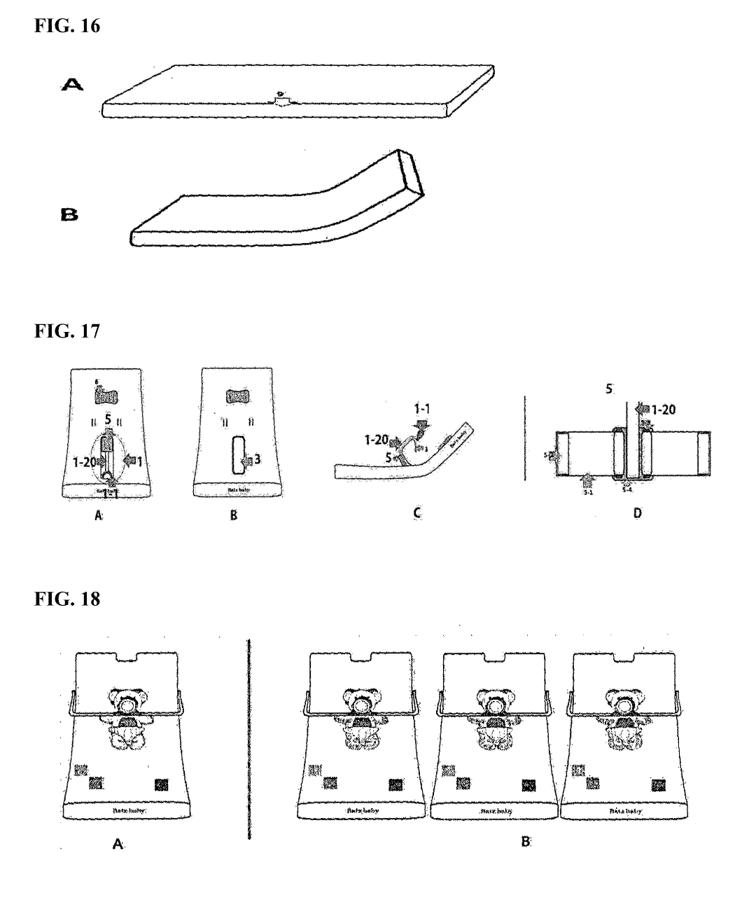

B shows a condition in which the injury prevention auxiliary arm (=inner cylinder) 20-3 is drawn out to the outside of the outer cylinder. (a condition in which an impact applied to the injury prevention auxiliary arm (=inner cylinder) 20-3 is removed and the injury prevention auxiliary arm (=inner cylinder) 20-3 is returned to its original position) However, FIG. 10 is applied to the auxiliary bottle feeding apparatus 1 in which the horizontal arm 20-2 and the bottle holder 10-1 are perpendicular to each other, that is, the auxiliary bottle feeding apparatus 1 as in the case of C of FIG. 15, and if the present structure is to be applied to the auxiliary bottle feeding apparatus 1 of FIGS. 8 and 14, it can be easily embodied by constituting the horizontal arm 20-2 of FIG. 14 to be curved in a U shape parallel to the ground surface (not shown).

In the meantime, the injury prevention auxiliary arm 20-3 is a constituting element which extends the function of the bottle fix means advance and retreat means 10-8 which is a constituting element described above.

For example, the distance by which the bottle holder 10-1 can advance and retreat in FIG. 6 described above is affected by the length of the spacing formation section 10-10 and the rail 10-3, and if the length of the spacing formation section 10-10 and the rail 10-3 is extended to extend the distance of advance and retreat, the volume of the bottle fix section 1-10 to which the two constituting elements belong is accordingly increased and the volume of the entire auxiliary bottle feeding apparatus 1 is also increased, and therefore this cannot be regarded as a preferable structure. However, in case where the injury prevention auxiliary arm 20-3 is used as the bottle fix means advance and retreat means 10-8, the length is similar to that of the horizontal arm 20-2 and therefore the length of advance and retreat of the bottle holder 10-1 can also be extended to a range similar to the length of the horizontal arm 10-2, and the volume of the entire auxiliary bottle feeding apparatus 1 is not increased. In addition, the spacing between the baby and the bottle fix section 1-10 is extended at the time of crash and the baby can be protected more safely so that this can be a very preferable embodiment.

In addition, since this structure makes it possible for the auxiliary bottle feeding apparatus 1 to be mounted further distant from the baby seated in the bottle feeding posture, it provides an advantage of further reinforcing the safety of the baby.

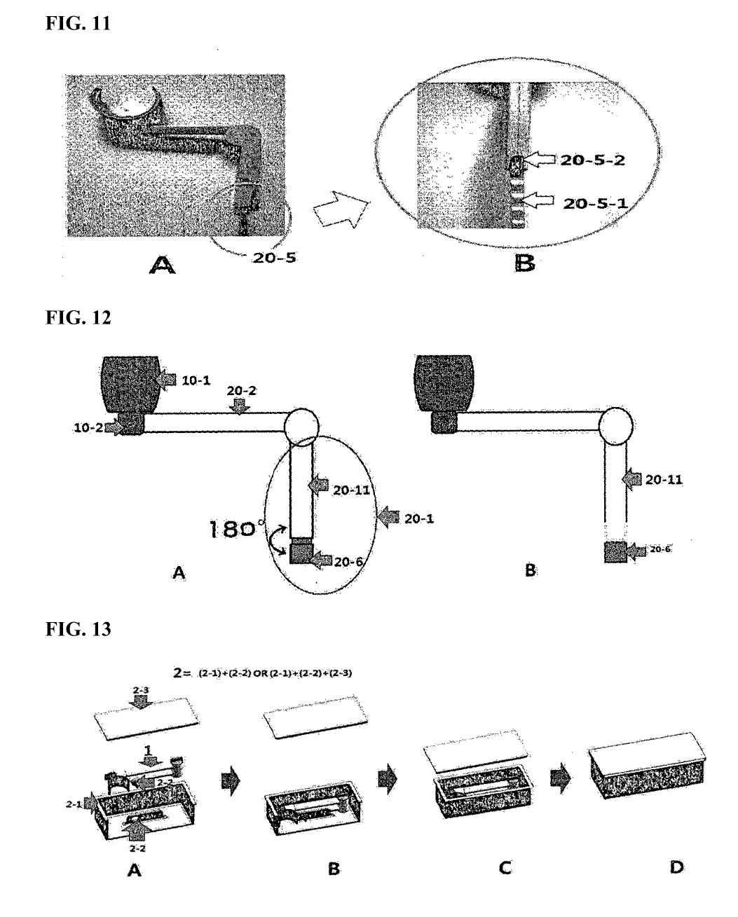

Hereinafter, FIG. 11 will be referred to.

FIG. 11 shows the auxiliary bottle feeding apparatus height adjustment means 20-5 which has as the constituting element the vertical arm 20-1 which includes as the constituting element an outer cylinder 20-11, height adjustment arm (=inner cylinder) 20-5-1, and height adjustment arm fix means 20-5-2.

The auxiliary bottle feeding apparatus height adjustment means 20-5 is a constituting element which performs the function of changing the height of the auxiliary bottle feeding apparatus 1 through the change of the height of the horizontal arm 20-1.

The auxiliary bottle feeding apparatus height adjustment means 20-5 is constituted so that a predetermined space is formed in the vertical arm 20-1 and the height adjustment arm (=inner cylinder) 20-5-1 of the structure of loose combination with the outer cylinder 20-11 can be drawn in and out of the space.

In addition, the height adjustment arm fix means 20-5-2 is formed at the ends of the height adjustment arm (=inner cylinder) 20-5-1 and the outer cylinder 20-11, and the height adjustment arm (=inner cylinder) 20-5-1 is not entirely drawn out to the outside and is fixed. On the other hand, the sections of the height adjustment arm (=inner cylinder) 20-5-1 and the outer cylinder 20-11 are preferably polygon.

A of FIG. 11 shows a condition in which the height adjustment arm (=inner cylinder) 20-5-1 is drawn out from the outer cylinder 20-11.

B is an enlarged drawing of A.

The auxiliary bottle feeding apparatus height adjustment means 20-5 provides an advantage of enabling the height of the bottle to be adjusted to suit the sitting height of the baby seated in the bottle feeding posture.

Hereinafter, FIG. 12 will be referred to.

FIG. 12 shows the auxiliary bottle feeding apparatus horizontal rotation means 20-6 constituted as the rotary loose combination means.

The auxiliary bottle feeding apparatus horizontal rotation means 20-6 mutually combines two members, which are constituted by horizontally dividing the vertical arm 20-2 into two parts at a point selected on the vertical arm 20-2, by using a rotatable combination means.

(* Inner half circle: a space placed between the horizontal arm 20-2 and the baby seated. Outer half circle: a space corresponding to the inner half circle. Dividing into two parts: dividing a member into two parts in lengthwise direction)

The auxiliary bottle feeding apparatus horizontal rotation means 20-6 provides an advantage of preventing the injury of the baby by naturally rotating the auxiliary bottle feeding apparatus 1 in the direction of progress of the crash in case where the baby is crashed by the horizontal arm 20-2.

Hereinbefore, the main constituting elements of the auxiliary bottle feeding apparatus according to the present invention and the additional constituting elements of the auxiliary bottle feeding apparatus have been described in detail.

In the meantime, the auxiliary bottle feeding apparatus of all structures according to the description of FIGS. 1 to 12 may further include an auxiliary bottle feeding apparatus reception means (case) 2 as an additional structure.

Hereinafter, FIG. 13 will be referred to.

FIG. 13 shows the auxiliary bottle feeding apparatus reception means (case) 2 which is a container which houses the entire or a part of the auxiliary bottle feeding apparatus 1 of all above described structures.

A of FIG. 13 shows a reception container 2-1, combination means 202, and opening and closing means 2-3 which are the constituting elements of the auxiliary bottle feeding apparatus reception means (case) 2.

B, C, and D show processes by which the auxiliary bottle feeding apparatus 1 is received into the auxiliary bottle feeding apparatus reception means (case) 2.

The reception container 2-1 is a container for housing the auxiliary bottle feeding apparatus 1, and can be constituted through a structure selected among the structure of housing the entire of the constituting elements of the auxiliary bottle feeding apparatus 1 and the structure of housing a part of the constituting elements as shown.

The combination means 2-2 is a means for combining the auxiliary bottle feeding apparatus 1 and the reception container 2-1, and can use both of a pure combination means and rotary combination means.

However, in case of using the pure combination means, another combination means may be additionally required to erect the auxiliary bottle feeding apparatus 1 in vertical direction in the reception container 2-1.

The auxiliary bottle feeding apparatus reception means (case) 2 can be mounted at any place the manufacturer wants such as the front, side, back, deep part, and of course, can be mounted in concealment type to be built-in on the auxiliary bottle feeding apparatus reception space 4 which is another reception means which will be described below.

In addition, the material constituting the auxiliary bottle feeding apparatus reception means (case) 2 can be changed to a synthetic resin formed member, fabric material, leather material, wood material, steel material, fabric material in which filler materials are stacked.

The opening and closing means 2-3 is a constituting element closing the opening hole of the reception container 2-1, and can be constituted by various materials, and in particular, its outside can be sheathed by using the fabric material in which filler materials are stacked. However, the opening and closing means 2-3 can be omitted if necessary.

In the meantime, the auxiliary bottle feeding apparatus reception means (case) 2 of the structure described provides advantages in that it prevents the damage of the auxiliary bottle feeding apparatus 1 mounted on the baby product so as to increase the durability, and makes the auxiliary bottle feeding apparatus 1 not to be exposed to the outside so as to improve the virtual beauty, and also prevents the injury of the baby in case where the baby is crashed by the auxiliary bottle feeding apparatus 1.

(* Pure combination means: means which simply combines. Rotary combination means: combination means having a rotation function)

Hereinbefore, all structures of the auxiliary bottle feeding apparatus 1 according to the present invention have been described.

However, all of the above described structures are simple embodiments suggested to enhance the structure of the present invention and the present invention is not limited to them.

Hereinafter, the structure of the baby product to which the auxiliary bottle feeding apparatus is mounted.

The baby product to which the auxiliary bottle feeding apparatus is mounted includes as main constituting elements the auxiliary bottle feeding apparatus, the baby product, and the combination means which connects the auxiliary bottle feeding apparatus and the baby product.

The auxiliary bottle feeding apparatus 1 which is the main constituting element according to the present invention is constituted through a structure selected among 1) a structure having as constituting elements the arm section 1-10, the bottle fix section 1-20, and the combination means for combining the auxiliary bottle feeding apparatus 1 of the above structure and the baby product, and 2) a structure having as constituting elements the arm section 1-10, the bottle fix section 1-20, the auxiliary bottle feeding apparatus reception means (case) 2, and the combination means for combining the auxiliary bottle feeding apparatus 1 of the above structure and the baby product. (* Refer to the description of the structure of the auxiliary bottle feeding apparatus described above)

The baby product which is the main constituting element according to the present invention includes a car safety seat for baby, baby carriage, baby bed, baby mattress, baby carrier, baby hip sack, baby transportation waist sack, baby sofa, baby chair, baby auxiliary chair, baby bottle feeding cushion, baby rocking bed, baby walker, bottle feeding cradle, etc. However, the baby product is not necessarily limited to this.

(* Baby transportation hip sack: easy carrier constituted by a waist belt worn on the waist of mother and a baby hip seating seat. Baby auxiliary chair: used for seating the baby alone at home or in the restaurant, etc., chair having a safety belt)

The baby product can be constituted through a structure of forming an opening hole at a selected predetermined position on the baby product and further including the auxiliary bottle feeding apparatus reception space 4 which is a space recessed toward a deep part of the baby product body.

The auxiliary bottle feeding apparatus reception space 4 has a reception space 4-1 as a constituting element, and can further have a combination means 4-2 and an opening and closing means 4-3.

The combination means 4-2 is a constituting element for fixing the auxiliary bottle feeding apparatus in the reception space 4-1.

(* At this time, the auxiliary bottle feeding apparatus includes both of a structure including the auxiliary bottle feeding apparatus reception means (CASE) and a structure not including it.)

The reception space 4-1 can be freely constituted at desired place such as the front, back, side, deep part, etc. of the baby product, and the entire or part of the constituting elements of the auxiliary bottle feeding apparatus 1 can be built-in in the space. (* At this time, the auxiliary bottle feeding apparatus the auxiliary bottle feeding apparatus includes both of a structure including the auxiliary bottle feeding apparatus reception means (CASE) and a structure not including it.)

In addition, the reception space 4-1 provides advantages in that it makes the auxiliary bottle feeding apparatus 1 to be built-in in the baby product body so as to protect the auxiliary bottle feeding apparatus 1 and improve the durability, and provides the easiness of the deposit, and also prevents the injury of the baby and improves the esthetic sense of the baby product due to the simple appearance.

In addition, the reception space 4-1 can be constituted through a structure further including the opening and closing means 4-3 for closing the opening hole, and in this case, since the auxiliary bottle feeding apparatus 1 is concealed in the baby product body, the apparatus cannot be recognized from outside and the esthetic sense of the baby product is further increased.

The surface of the opening and closing means 4-3 can be coated with a sheath including a filler material.

The combination means 4-2 is a means for fixing the auxiliary bottle feeding apparatus in the reception space 4-1.

Hereinafter, FIG. 14 is referred to.

FIG. 14 shows the procedure of use of the auxiliary bottle feeding apparatus.

A (seating the baby to the bottle feeding position)→B (placing the auxiliary bottle feeding apparatus to the bottle feeding position)→C (mounting the bottle)→D (bottle feeding)→E (bottle feeding end)

Hereinafter, FIG. 15 will be referred to.

FIG. 15 shows the baby mattress to which the auxiliary bottle feeding apparatus is mounted, being a kind of baby product to which the auxiliary bottle feeding apparatus 1 is mounted. In addition, this includes a body fix guard 5, a head fix guard 6, and a mattress erection means 7 as additional constituting elements.

The body fix guard 5 is a constituting element for performing the support stand function to prevent the inclination to the left or right of the body of the baby seated in the bottle feeding position or sliding of the body while bottle feeding. This may be constituted in various forms such as a form of wrapping the periphery of the baby body, a form of concurrently wrapping the body and the crotch part, and an inclined pedestal inserted between the crotches of the baby. In addition, the constituting material and the structure can be changed to various material and structure such as a synthetic resin material, rubber material, fabric material, leather material, etc.

The head fix guard 6 is a constituting element for performing the support stand function to prevent the inclination to the left or right of the head of the baby of age of few months seated in the bottle feeding position, and the preferable example is one of pillow type of a structure in which a high jaw is formed at both sides left and right of the head of the baby as shown. The time when the baby uses the bottle as the bottle feeding means is time of berth ˜3 years, and the baby in particular 3˜4 months after berth in the development process cannot control the head and needs the head fix guard 6.

The mattress erection means 7 is a constituting element which can easily pull the baby mattress in case of erecting the baby mattress to a desired angle at the time of bottle feeding. It can be constituted in the form of a handle, however, it is not necessarily limited to that form, can be changed to an electronic driving apparatus using an automatic gear apparatus if necessary.

A is the baby mattress in which the auxiliary bottle feeding apparatus is mounted in front.

a is an embodiment in which the auxiliary bottle feeding apparatus having the bottle fix section, the arm section and the combination means as the constituting elements is mounted.

b is an embodiment in which the auxiliary bottle feeding apparatus including the bottle fix section, the arm section, the combination means and the auxiliary bottle feeding apparatus reception means (case) 2 as the constituting elements is mounted in the auxiliary bottle feeding apparatus reception space formed in the front left of the baby mattress.

c is an embodiment in which the auxiliary bottle feeding apparatus including the bottle fix section, the arm section, the combination means, the auxiliary bottle feeding apparatus reception means (case) and the opening and closing means as the constituting elements is mounted in the auxiliary bottle feeding apparatus reception space.

B is the baby mattress in which the auxiliary bottle feeding apparatus having the bottle fix section, the arm section and the combination means as the constituting elements is mounted in the side.

a is an embodiment in which the auxiliary bottle feeding apparatus having the bottle fix section, the arm section of cobra type and the combination means as the constituting elements is mounted in the side of the baby mattress.

b is the baby mattress of a structure in which the auxiliary bottle feeding apparatus including the bottle fix section, the arm section, the combination means and the auxiliary bottle feeding apparatus reception means (case) 2 as the constituting elements is mounted in the auxiliary bottle feeding apparatus reception space at the side of the baby mattress.

c is a condition in which above said b is developed in the bottle feeding position.

C is the baby mattress in which the auxiliary bottle feeding apparatus is mounted in front low end.

a is an embodiment in which the auxiliary bottle feeding apparatus including the bottle fix section, the arm section, the combination means and the auxiliary bottle feeding apparatus reception means (case) as the constituting elements is mounted in the auxiliary bottle feeding apparatus reception space formed in the center low end of the baby mattress.

b is an embodiment of a structure further including the opening and closing means 3 at the above said a.

D is the baby mattress in which the auxiliary bottle feeding apparatus having an archery type arm section is mounted.

a is an embodiment in which the auxiliary bottle feeding apparatus including the bottle fix section, the arm section (archery type arm section), and the combination means as the constituting elements is mounted (closely attached) in the upper end of the baby mattress.

b is a condition in which above said b is developed in the bottle feeding position.

c is a condition in which the bottle 8 is mounted at the above said b.

d is an embodiment in which the bottle fix section being a part of the auxiliary bottle feeding apparatus is built-in in the auxiliary bottle feeding apparatus reception means (case).

e and f are embodiments of the baby mattress having the arm section (transformed archery type), the bottle fix section, the combination means, and the auxiliary bottle feeding apparatus reception space (transformed).

(e is a condition in which the bottle fix section of the auxiliary bottle feeding apparatus having the transformed archery type arm section is mounted in the transformed auxiliary bottle feeding apparatus reception space formed at the upper end of the baby mattress. f is a condition in which said e is developed in the bottle feeding position.

E shows the baby mattress in which the auxiliary bottle feeding apparatus of the concealment type is mounted.

a is an embodiment in which the auxiliary bottle feeding apparatus including the bottle fix section, the arm section, and the combination means as the constituting elements is concealed in the auxiliary bottle feeding apparatus reception space 4 formed transverse at the deep part of the baby mattress. In particular, it shows a condition in which the auxiliary bottle feeding apparatus having the cobra type arm section is received transverse.

b is a condition in which above said b is developed in the bottle feeding position.

Hereinafter, FIG. 16 will be referred to.

FIG. 16 shows the baby mattress in which a back rest angle adjustment means 9 being a constituting element for erecting the back rest of the baby mattress to a desired angle is mounted.

A shows the baby mattress which is completely laid down on the floor.

B shows the baby mattress which is erected to a desired angle by using the back rest angle adjustment means 9.

Hereinafter, FIG. 17 will be referred to.

FIG. 17 is a detailed drawing of “the baby mattress C in which the auxiliary bottle feeding apparatus is mounted in front low end′ which was described through FIG. 15, and additionally shows a side elevation drawing and a body fix guard 5.

A is an embodiment in which the auxiliary bottle feeding apparatus including the bottle fix section, the arm section, the combination means and the auxiliary bottle feeding apparatus reception means (case) as the main constituting elements is mounted in the auxiliary bottle feeding apparatus reception space 4 formed in the center low end of the baby mattress.

B is an embodiment of a structure further including the opening and closing means at the above said a.

C is a side elevation drawing of “the baby mattress C in which the auxiliary bottle feeding apparatus is mounted in front low end’.

It shows the baby mattress in which the auxiliary bottle feeding apparatus is mounted, wherein the auxiliary bottle feeding apparatus including the arm section 1-20, the baby mattress fix section 1-1, combination means, and the auxiliary bottle feeding apparatus reception means (case) 2 as the main constituting elements is mounted on the baby mattress including the auxiliary bottle feeding apparatus reception space 4, the body fix guard 5, and the head fix guard 6 as the partial constituting elements.

D shows the body fix guard 5 of a structure including a body band 5-1, remove and attachment means 5-2, automatic winding apparatus 5-3, and crotch support 5-4.

The body fix guard 5 is a constituting element used as a means for fixing the body to prevent the inclination to the left or right of the body of the baby seated in the bottle feeding posture or sliding forward.

In addition, the body fix guard 5 can be manufactured by using all kind of constituting material such as a fabric material, plastic material, leather material, etc.

In addition, the body fix guard 5 may be constituted in various forms such as a form of wrapping the body, an inclined pedestal inserted between the crotches of the baby, a form of concurrently wrapping the body and the crotch part, a form of safety belt type crossing the shoulder, and vest form.

In the meantime, the body band 5-1 is a means for wrapping and fixing the body of the baby.

The remove and attachment means 5-2 is a means for fixing the body band 5-1 on the mattress by using a Velcro tape, rail tape 11-7, buckle, ring, etc.

The automatic winding apparatus 5-3 has a function of automatically winding or unwinding the body band 5-1, and can be constituted so that it can be unwound by the pulling action of the user's hand.

The crotch support 5-4 is an inclination type member which is inserted between the crotches of the baby, and is a means of fixing by using the inclination to prevent the forward sliding of the baby. As the material constituting the crotch support, the synthetic resin can be used as a preferred example.

Hereinafter, FIG. 18 will be referred to.

FIG. 18 is a drawing of the use of the baby mattress.

A is for use at home.

B is the baby mattress of a structure in which plural baby mattress constituted to be suitable to be used at a facility of taking care of babies, bottle feeding room in department, facility of taking care of babies in a company are connected.

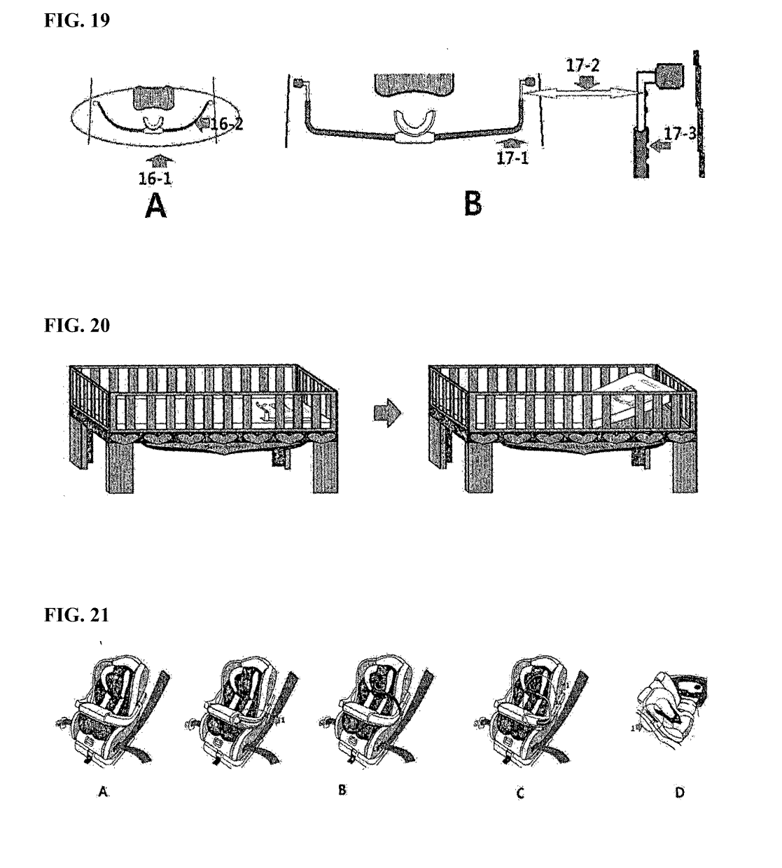

Hereinafter, FIG. 19 will be referred to.

FIG. 19 shows the arm section 1-20 of the archery type of a structure including a latch protrusion 20-12 and latch hole 20-13 as a height adjustment means of the auxiliary bottle feeding apparatus having the archery type arm section.

The arm section of the present structure is constituted by the combination of the outer cylinder formed with the latch hole 20-13 and the inner cylinder formed with the latch protrusion 20-12, and is constituted to adjust the height of the auxiliary bottle feeding apparatus through the action of pulling or pressing the outer cylinder.

Hereinbefore, the baby mattress according to the structure of the present invention has been described.

Hereinafter, other baby products to which all kinds of structures pointed through the contents described above likewise the baby mattress.

Hereinafter, FIG. 20 will be referred to.

<Baby Bed>

The baby bed to which the auxiliary bottle feeding apparatus according to the present invention is mounted can be easily constituted by mounting the “baby mattress to which the auxiliary bottle feeding apparatus is mounted” to a bed for the baby bed. However, it is not necessarily limited to this structure, but the structure in which the auxiliary bottle feeding apparatus is mounted on a frame which constitutes the bed also falls into the present invention.

Hereinafter, FIG. 21 will be referred to.

<Car Safety Seat for Baby>

A is a usual car safety seat for baby.

B is the car safety seat for baby of a structure in which the auxiliary bottle feeding apparatus 1 is mounted at the outer periphery of the safety guard. In particular, it is the auxiliary bottle feeding apparatus 1 having the arm which is constituted by one member.

C is the car safety seat for baby of a structure in which the auxiliary bottle feeding apparatus 1 is built-in in the auxiliary bottle feeding apparatus reception space formed in the safety guard. In particular, it is the auxiliary bottle feeding apparatus 1 having the cobra type arm.

D is the car safety seat for baby of a structure in which the auxiliary bottle feeding apparatus 1 is mounted at the side of the car safety seat for baby. In particular, it is the auxiliary bottle feeding apparatus 1 of the folding type having the arm which is constituted by two or more members.

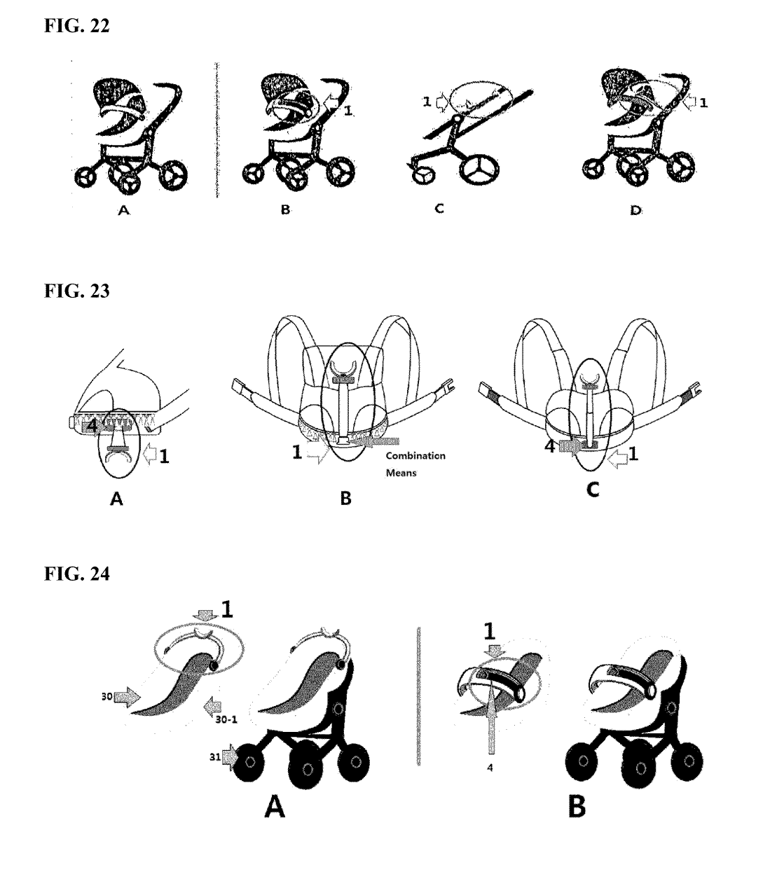

Hereinafter, FIG. 22 will be referred to.

<Baby Carriage>

A is a usual baby carriage.

B is a baby carriage of a structure in which the auxiliary bottle feeding apparatus 1 is mounted in the auxiliary bottle feeding apparatus reception space formed on the safety guard.

C is a baby carriage of a structure in which the retraction type auxiliary bottle feeding apparatus 1 is mounted at the side of the baby carriage.

D is a baby carriage of a structure in which the auxiliary bottle feeding apparatus 1 is mounted in the auxiliary bottle feeding apparatus reception space formed in the baby carriage handle. In particular, it is the auxiliary bottle feeding apparatus 1 having the cobra type arm.

E is a baby carriage of a structure having the arm section (archery type arm section) crossing the front of the baby carriage (not shown).

At the time of non-bottle feeding, the arm section (archery type arm section) can be deposited by moving it to the back of the baby carriage.

Hereinafter, FIG. 23 will be referred to.

<Baby Carrier>

The baby carrier is a baby product of a structure which is newly suggested through the present invention. (A detailed structure of this will be described later.)

A is a side elevation drawing of the baby carrier, and shows the baby carrier of a structure in which the auxiliary bottle feeding apparatus is mounted in the auxiliary bottle feeding apparatus reception space 4 installed at the side of the seating seat of the baby carrier. At the time of non-bottle feeding, the auxiliary bottle feeding apparatus 1 is concealed in the auxiliary bottle feeding apparatus reception space 4.

B shows the baby carrier of a structure in which the auxiliary bottle feeding apparatus 1 having the vertical arm section is mounted in the front of the baby carrier. In particular, it is the auxiliary bottle feeding apparatus constituted to be normally developed in the bottle feeding position.

C shows the baby carrier of a structure in which the auxiliary bottle feeding apparatus is mounted in the auxiliary bottle feeding apparatus reception space 4 installed in front of the seating seat of the baby carrier. At the time of non-bottle feeding, the auxiliary bottle feeding apparatus 1 is concealed in the auxiliary bottle feeding apparatus reception space 4.

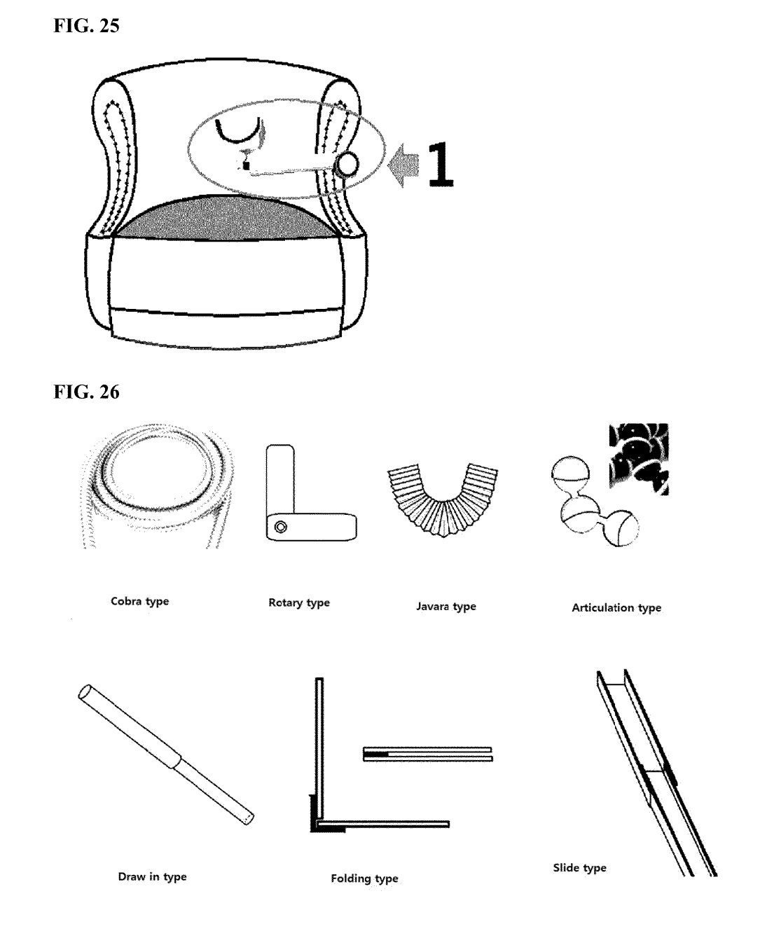

Hereinafter, FIG. 24 will be referred to.

<Bottle Feeding Cradle>

The bottle feeding cradle is a baby product which is newly suggested through the present invention, and is constituted through a structure including a seating basket 30 and the auxiliary bottle feeding apparatus 1 as the main constituting elements.

In addition, the bottle feeding cradle can be constituted by mounting plural wheels being a movement means 31 at the low end of the seating basket so that the movement of the bottle feeding cradle is convenient.

In addition, the seating basket 30 can be constituted through one structure selected among a structure in which the back rest being a part of the floor surface and a structure further including a back rest angle adjustment means (not shown) which can erect the back rest to a desired angle.

A is the bottle feeding cradle to which the auxiliary bottle feeding apparatus having the arm section (archery type arm section) crossing the seating basket 30, wherein the left side shows an embodiment of a structure in which the movement means 31 is omitted, and the right side shows an embodiment of a structure including the movement means 31.

B is the bottle feeding cradle of a structure in which the auxiliary bottle feeding apparatus 1 is mounted in the auxiliary bottle feeding apparatus reception space 4 formed at the safety guard, wherein the left side shows an embodiment of a structure in which the movement means 31 is omitted, and the right side shows an embodiment of a structure including the movement means 31.

Hereinafter, FIG. 25 will be referred to.

<Baby Sofa>

It shows a structure in which the retraction type auxiliary bottle feeding apparatus 1 is mounted at the side of the sofa.

In addition, the auxiliary bottle feeding apparatus of a structure in which the auxiliary bottle feeding apparatus is mounted at the front, back, and deep part of the sofa and of a structure having the archery type arm section is mounted at the upper end of the sofa and is developed into the bottle feeding position at the front of the sofa and is used, and at the time of non-bottle feeding, may be passed over the back of the back rest of the sofa to be deposited

Hereinafter, FIG. 26 will be referred to.

FIG. 26 shows various embodiments of the member constituting the arm section 1-20 of the auxiliary bottle feeding apparatus 1.

All of these are retractable, and show A cobra type, B rotary retraction type, C jabara type, D articulation retraction type, E drawing in type retraction type, F folding type retraction type, and G slide type retraction type.

However, the arm section of the auxiliary bottle feeding apparatus according to the present invention can be constituted as a non-retraction type, and a synthetic resin molded member, wood molded member, metal molded member, wire curved member, etc. constituted as one member can be included in this as preferred embodiments.

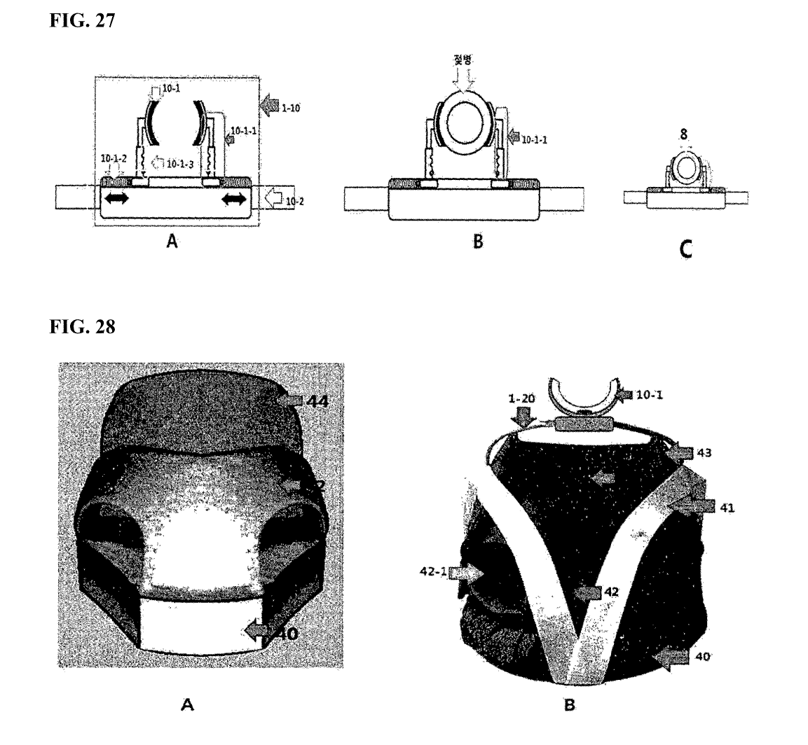

Hereinafter, FIG. 27 will be referred to.

FIG. 27 is a changed embodiment of the bottle holder, and in particular, one bottle holder which is completed by combination of two members which are divided into both of left and right and the bottle is mounted between the two members, this being the method of fixing by applying a pressure at the left and right sides of the bottle holder which is mounted by the action of the pressure member (spring) 10-1-2 installed at the lower end of each of above said left and right members, enabling mounting of the bottle of various sizes and it use by changing the movement distance of the pressure member according to the diameter of the bottle to be mounted.

Hereinbefore, FIGS. 1 to 27 have been described.

Hereinafter, the baby carrier of new structure according to the present invention will be described through accompanying FIGS. 28 to 35.

The baby carrier according to the present invention is constituted through a structure including a seating seat 40, front safety guard 42 and shoulder traction string 41 as the constituting elements.

In addition, the baby carrier according to the present invention may be constituted through a structure further including one or more constituting elements among a side safety guard 43 and rear safety guard 44 as the additional constituting elements to the above said structure upon necessity, and in case where the side safety guard and rear safety guard are concurrently installed, these can be replaced with a vest type safety guard 45.

In addition, the baby carrier according to the present invention may be constituted through a structure further including the auxiliary bottle feeding apparatus as the additional constituting elements

The seating seat 40 is a main constituting element, and is a constituting element for seating the hips of the baby.

The front safety guard 42 is a three dimensional face like member which wraps the stomach portion of the baby to prevent the forward falling of the baby seated on the seating seat 40, and is erected at the edge of the front of the seating seat, and is constituted by including two penetration holes to which two legs of the baby can be inserted.

The shoulder traction string 41 is a constituting element for combining the baby carrier to the mother who is a transporter.

In addition, the shoulder traction string 41 is a constituting element for balancing the baby carrier by preventing the baby carrier from being inclined to any direction including left, right, forward and rearward in the condition of combining the baby carrier to the mother, is designed in consideration of the center of the weight of the baby carrier, and is usually installed at positions corresponding to left and right of the body of the carrier and is fixed through the shoulder, back and waist of the mother, and one ends of the two traction strings for shoulder 41 are respectively combined to front left (or right) of the carrier body, and the other ends forms a junction point at the back side of the waist of the mother and are mutually combined by using a combination means constituted to combine the two traction strings for shoulder.

The side safety guard 43 is a three dimensional face like member which wraps both waist portions to prevent the side falling of the baby from the seating seat 40, and is erected at both side edges of the seating seat.

(In the meantime, in case where the front safety guard and the side safety guard are concurrently installed, they may be replaced with a front and side safety guard which is constituted by mutually integrating them. That is, the front and side safety guard is a constituting element (not shown) which concurrently wraps the front and the sides of the seating seat by using one member.)

The rear safety guard 44 is a three dimensional face like member which wraps back portion to prevent the rearward falling of the baby from the seating seat 40, and is erected at back side edge of the seating seat.

(In the meantime, in case where the side safety guard and the rear safety guard are concurrently installed, they may be replaced with a side and rear safety guard which is constituted by mutually integrating them. That is, the side and rear safety guard is a constituting element (not shown) which concurrently wraps the side and the rear of the seating seat by using one member.)

The vest type safety guard 45 includes one penetration hole penetrating the head of the baby and is a constituting element of the vest type which wraps the entire body of the baby, and the front end of the vest is connected to the front edge of the seating seat or to the upper edge of the front safety guard, and the back side end is connected to the rear edge of the seating seat.

The band type safety guard (not shown) is constituted by left and right one pair of strings, and one end of each string is connected to the front safety guard and is extended to the back of the baby in the condition of seating, and the other end is connected in the form of ∥ or X to left and right of the back side edge of the baby carrier. This can replaces the vest type safety guard 44-1.

The front and side safety guard (not shown) is a three dimensional face like member which concurrently wraps the stomach and the waist of the baby to prevent the forward and side falling of the baby from the seating seat 40, and is erected at front and side edges of the seating seat as one member.

The side and rear safety guard (not shown) is a three dimensional face like member which concurrently wraps waist and the back of the baby to prevent the side and rearward falling of the baby from the seating seat 40, and is erected at side and rear edges of the seating seat as one member.

In the meantime, all guards which include the above said seating seat 40 can be constituted by a resin expanded molded part or a resin expanded bead molded part, and the surface of the resin expanded molded part or the resin expanded bead molded part can be coated through a predetermined method selected among methods of the fabric coating, leather coating, and fiber flocking.

Hereinbefore, the main constituting elements and the additional constituting elements of the baby carrier of new structure according to the present invention have been described.

Hereinafter, the manufacturing method of the baby carrier will be described.

The body of the baby carrier according to the present invention can be constituted by a resin expanded part, and as the constituting material of the resin expanded part, the resin expanded foam and the resin expanded beads can be used.

In addition, the resin expanded part (the resin expanded foam and the resin expanded beads) includes the structures of both the single color and mixed color.

In addition, the outside of the resin expanded part can be coated through the methods of fabric coating, resin film coating, and fiber flocking coating if necessary.

(* Body: a structure including the seating seat and further including at least one among the front safety guard, side safety guard and rear safety guard to the above described structure/fiber flocking: a method of forming an adhesive layer to the surface of an object to be coated and thereafter coating the surface by bonding fiber particle to the surface)

The resin raw material for manufacturing the above said resin expanded part includes as the preferred examples PP (polypropylene), PE (polyethylene), and PS (polystyrene).

In addition, As the RESIN EXPANDED BEADS, EPP (EXPANDED-PP BEADS), EPE (EXPANDED-PE BEADS), and EPS (EXPANDED-PS BEADS) are included. However, it is not necessarily limited to those, but may include all of a resin foam and RESIN EXPANDED BEADS which are manufactured by using a raw material obtained by further adding, as additional raw materials, raw materials of one or more kinds selected among the synthetic resins of one or more kinds, synthetic resin elastomer, and rubber resins to the above said raw materials. However, using PP (polypropylene), PE (polyethylene), and PS (polystyrene) which are known as the raw materials not harmful to the human body may be a preferred embodiment.

In addition, as the adhesives, urethane adhesive, epoxy adhesive, etc. may be easily used, however, it is not necessarily limited to those.

The above said RESIN EXPANDED BEADS is manufactured by heat expanding by putting into a thermal water bath a granular resin raw material filled with gas for expanding, and can be manufactured into beads of all of desired colors, and this characteristic can be used as esthetic elements in manufacturing the baby carrier.

In the meantime, as the method of manufacturing the constituting elements of the baby carrier by using the resin raw material or the RESIN EXPANDED BEADS raw material, the seating seat, front safety guard, side safety guard, and rear safety guard, etc. can be manufactured through the method of putting a predetermined amount of the resin raw material, EPP or EPE into a mold of a shape to be manufactured, closing the opening hole, and heat expanding the mold with the steam pressure of about 1.5˜4 cm/kgf.

Hereinafter, embodiment of each constituting element on the baby carrier constituted by the resin expanded part will be described.

1) A constituting element obtained by cutting a resin expanded preform obtained by expanding the resin raw material,

2) a constituting element obtained by putting the resin raw material into a mold of a shape to be manufactured and heat expanding it,

3) a constituting element obtained by cutting, into a desired shape, the RESIN EXPANDED BEADS preform manufactured by heat expanding the RESIN EXPANDED BEADS manufactured by heat expanding the granular resin raw material.

4) a constituting element obtained by putting the RESIN EXPANDED BEADS into a mold of a shape to be manufactured and heat press molding it,

5) a constituting element obtained by putting a mixture of the RESIN EXPANDED BEADS and the adhesive into a mold of a shape to be manufactured and press molding or heat press molding it,

6) a constituting element manufactured by heat press molding or press molding the resin raw material or the RESIN EXPANDED BEADS in which the raw materials having two or more colors are mutually mixed.

(* resin expanded preform, RESIN EXPANDED BEADS preform: expanded parts of sheet phase or bulk phase)

Hereinafter, the main constituting elements and the additional constituting elements of the baby carrier of new structure according to the present invention have been described.

Hereinafter, the manufacturing method of the baby carrier will be described.

The body of the baby carrier according to the present invention can be constituted by a resin expanded part, and as the constituting material of the resin expanded part, the resin expanded foam and the resin expanded beads can be used.

In addition, the resin expanded part (the resin expanded foam and the resin expanded beads) includes the structures of both the single color and mixed color.

In addition, the outside of the resin expanded part can be coated through the methods of fabric coating, resin film coating, and fiber flocking coating if necessary.

(* Body: a structure including the seating seat and further including at least one among the front safety guard, side safety guard and rear safety guard to the above described structure/fiber flocking: a method of forming an adhesive layer to the surface of an object to be coated and thereafter coating the surface by bonding fiber particle to the surface)

The resin raw material for manufacturing the above said resin expanded part includes as the preferred examples PP (polypropylene), PE (polyethylene), and PS (polystyrene).

In addition, As the RESIN EXPANDED BEADS, EPP (EXPANDED-PP BEADS), EPE (EXPANDED-PE BEADS), and EPS (EXPANDED-PS BEADS) are included. However, it is not necessarily limited to those, but may include all of a resin foam and RESIN EXPANDED BEADS which are manufactured by using a raw material obtained by further adding, as additional raw materials, raw materials of one or more kinds selected among the synthetic resins of one or more kinds, synthetic resin elastomer, and rubber resins to the above said raw materials. However, using the PP (polypropylene), PE (polyethylene), and PS (polystyrene) which are known as the raw materials not harmful to the human body may be a preferred embodiment.

In addition, as the adhesives, an urethane adhesive, epoxy adhesive, etc. may be easily used, however, it is not necessarily limited to those.

The above said RESIN EXPANDED BEADS is manufactured by heat expanding by putting into a thermal water bath a granular resin raw material filled with gas for expanding, and can be manufactured into beads of all of desired colors, and this characteristic can be used as esthetic elements in manufacturing the baby carrier.

In the meantime, as the method of manufacturing the constituting elements of the baby carrier by using the resin raw material or the RESIN EXPANDED BEADS raw material, the seating seat, front safety guard, side safety guard, and rear safety guard, etc. can be manufactured through the method of putting a predetermined amount of the resin raw material, EPP or EPE into a mold of a shape to be manufactured, closing the opening hole, and heat expanding the mold with the steam pressure of about 1.5˜4 cm/kgf.

Hereinafter, embodiment of each constituting element on the baby carrier constituted by the resin expanded part will be described.

1) A constituting element obtained by cutting a resin expanded preform obtained by expanding the resin raw material,

2) a constituting element obtained by putting the resin raw material into a mold of a shape to be manufactured and heat expanding it,

3) a constituting element obtained by cutting, into a desired shape, the RESIN EXPANDED BEADS preform manufactured by heat expanding the RESIN EXPANDED BEADS manufactured by heat expanding the granular resin raw material.

4) a constituting element obtained by putting the RESIN EXPANDED BEADS into a mold of a shape to be manufactured and heat press molding it,

5) a constituting element obtained by putting a mixture of the RESIN EXPANDED BEADS and the adhesive into a mold of a shape to be manufactured and press molding or heat press molding it,

6) a constituting element manufactured by heat press molding or press molding the resin raw material or the RESIN EXPANDED BEADS in which the raw materials having two or more colors are mutually mixed.

(* resin expanded preform, RESIN EXPANDED BEADS preform: expanded parts of sheet phase or bulk phase)

Hereinafter, the structure of the baby carrier will be described through the accompanying drawings.

Hereinafter, FIG. 28 will be described.

A is an embodiment of a structure including a seating seat 40, a forward safety guard 42, and a rearward safety guard 44.

B is a baby carrier of a structure including as main constitutional elements the seating seat 40, the forward safety guard 42, a side safety guard 43, the rearward safety guard 44, and an auxiliary bottle feeding apparatus 1, and in particular, an embodiment of a structure in which the arm 1-20 of the form of an archery is mounted at the side of the rearward safety guard 44 of the baby carrier.

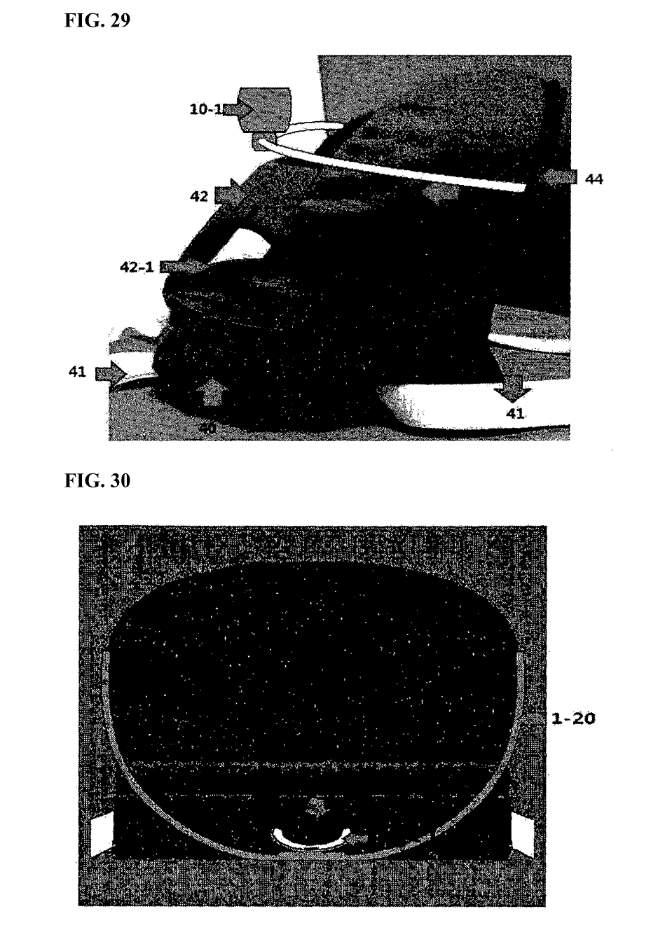

FIG. 29 is a side elevation drawing of the baby carrier in which the auxiliary bottle feeding apparatus 1 according to the present invention is mounted.

FIG. 30 shows the baby carrier having a structure in which the auxiliary bottle feeding apparatus reception space 4 is formed at the rear of the seating seat 40.

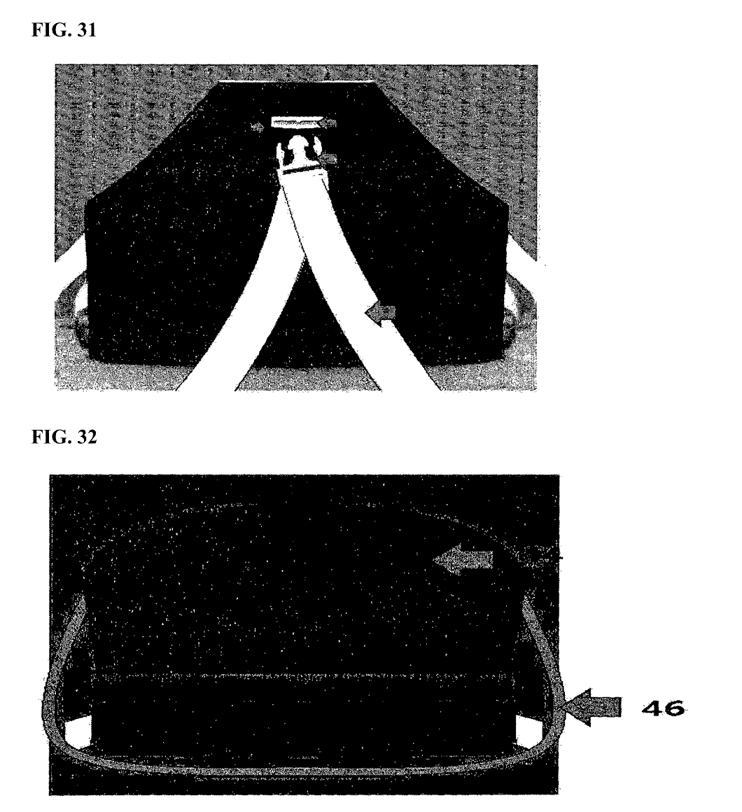

FIG. 31 is an embodiment of a structure in which a combination means 41-1 of a shoulder traction string 41 is formed at the bottom of the seating seat 40, and in particular, the combination means has a structure in which the opening hole is formed at the bottom of the seating seat 40 and the combination means is built-in in the opening hole.

FIG. 32 shows an embodiment of a structure in which an additional overturn prevention support stand 46 is formed at the rear of the baby carrier so that the baby carrier is not overturned rearward while being seated on the ground.

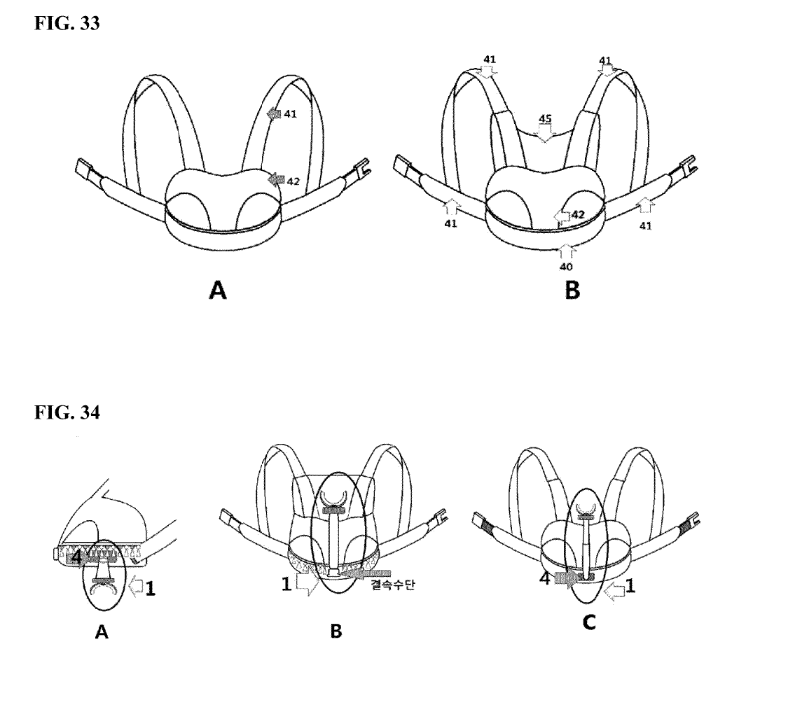

A of FIG. 33 shows the baby carrier including as constitutional elements the seating seat 40, the shoulder traction string 41, and the forward safety guard 42.

B shows the baby carrier of a structure including the seating seat 40, the shoulder traction string 41, the forward safety guard 42, and the vest type safety guard 45.

FIG. 34 shows the baby carrier having a structure including the seating seat 40, the shoulder traction string 41, the forward safety guard 42, a vest type safety guard 45, and the auxiliary bottle feeding apparatus 1.

A is an embodiment in which the auxiliary bottle feeding apparatus 1 is formed at the side of the seating seat 40.

B is an embodiment in which the auxiliary bottle feeding apparatus is mounted in front of the seating seat 40 by using the combination means.

C is an embodiment in which the auxiliary bottle feeding apparatus is mounted in the auxiliary bottle feeding apparatus reception means 4 formed in front of the seating seat 40.

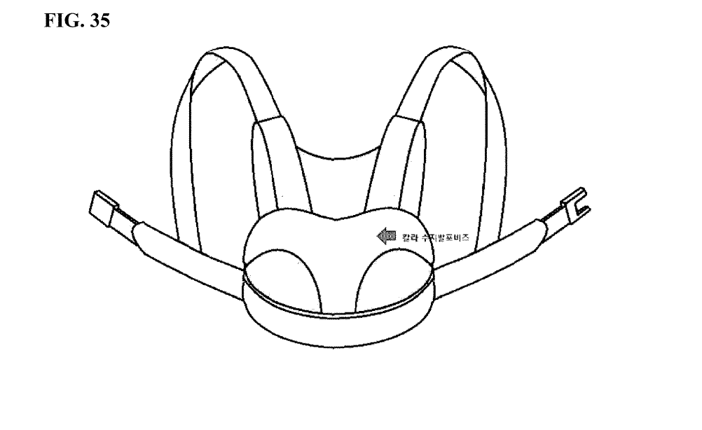

FIG. 35 is an embodiment of the baby carrier manufactured using resin expanded beads of more than two color tones as raw material.

As hereinbefore, the auxiliary bottle feeding apparatus 1 which is a constituting element according to the present invention can be freely installed at any place including the surface or inside of the body of the baby carrier as pointed out through the above described contents.

Hereinbefore, the structures according to the accompanying drawings have been described.

In the meantime, the baby carrier according to the present invention can be manufactured through a structure further including an awning to screen the sunray.

In addition, the baby product in which the auxiliary bottle feeding apparatus according to the present invention is mounted is a constituting element of an object of seeking the improvement of health and emotion of the baby while bottle feeding, and can be constituted through a structure further including one or more constituting elements selected among sound regeneration apparatuses if necessary.

In addition, the baby product in which the auxiliary bottle feeding apparatus according to the present invention can also be manufactured through a structure in which one or more constituting elements selected among a tassel tape, artificial jewel, HOT FIX, and spangle are sewed or bonded to enhance the esthetic element.

Hereinbefore, the structures of the auxiliary bottle feeding apparatus according to the present invention and the baby product to which the auxiliary bottle feeding apparatus is mounted have been described in detail.

In the meantime, the auxiliary bottle feeding apparatus according to the present invention can use a leak prevention pacifier (one which is constituted so that the milk is ejected out to the outside of the pacifier only when the baby bites the pacifier in the mouth and applies the pressure—for example; vivi pacifier) as a pacifier of the bottle to be mounted as a method for preventing the leakage of the mile which can occur in case where the pacifier is disengaged from the mouth of the baby at the time of bottle feeding.

* The auxiliary bottle feeding apparatus of the present invention can also be used as fluid supply apparatuses for pets and patients. In addition, the baby product to which the auxiliary bottle feeding apparatus is mounted can be manufactured as baby toys by reducing their shape.

### AVAILABILITY IN THE INDUSTRY

The present disclosure relates to various baby products which can be used as an auxiliary product in the procedure of taking care of a baby, and can be used in the field of an auxiliary bottle feeding apparatus which is a means for mounting a baby bottle on the baby product at the time of bottle feeding of the milk or baby food and a baby product to which the auxiliary bottle feeding apparatus is mounted which is manufactured by mounting the auxiliary bottle feeding apparatus.

What is claimed is:

1. An auxiliary bottle feeding apparatus and a baby product to which the auxiliary bottle feeding apparatus is mounted, comprising:
a bottle fix section for fixing the bottle by being combined to a combination means which is a constituting element additionally constituted on the bottle for the purpose of wrapping the entire or part of the bottle body excluding a pacifier or combining the bottle and the auxiliary bottle feeding apparatus;
an arm section being a member of a curved type or a type capable being curved which is constituted by having at least one rectangular member as a constituting element and which can realize the interior angle less than 180 degree; and
a combination means which is formed at one or more ends selected among two ends of the arm section and which is for combining the arm section on the baby product (or an additional constituting element which is constituted for the purpose of mounting the auxiliary bottle feeding apparatus on the baby product),
wherein, in the arm section, the at least one ends selected among the two ends of the arm section which the member of a curved type or a type capable being curved has are connected to selected positions (or an additional constituting element constituted for the mounting of the auxiliary bottle feeding apparatus) on the baby product, an extension section of the remaining rod excluding one end to be connected (or an extension section of the remaining rod excluding both ends to be connected) is extended to a space positioned in front of the baby seated in the bottle feeding posture on the baby product and passes without fail a space positioned in front of the face of the baby, and the bottle fix section is connected on the rod passing the front of the face of the baby.

2. The auxiliary bottle feeding apparatus and the baby product to which the auxiliary bottle feeding apparatus is mounted, of claim 1, wherein “the additional constituting element constituted for the mounting of the auxiliary bottle feeding apparatus” is an auxiliary bottle feeding apparatus reception means (CASE) which is a reception means for building-in the entire or part of the constituting elements on the auxiliary bottle feeding apparatus and for drawing out or in them, and wherein the auxiliary bottle feeding apparatus and the baby product to which the auxiliary bottle feeding apparatus is mounted further comprise the auxiliary bottle feeding apparatus reception means.

3. The auxiliary bottle feeding apparatus and the baby product to which the auxiliary bottle feeding apparatus is mounted, of claim 1 or 2, wherein the auxiliary bottle feeding apparatus is a structure for depositing by reducing the length or volume of the auxiliary bottle feeding apparatus when not in use and is constituted by a structure in which at least one constituting elements selected among the bottle fix section and the arm section.

4. The auxiliary bottle feeding apparatus and the baby product to which the auxiliary bottle feeding apparatus is mounted, of claim 1 or 2, wherein the arm section is constituted by one structure selected among the following structures:
1) a structure in which, under a condition where the auxiliary bottle feeding apparatus is developed into the bottle feeding position, one end of the arm section is connected at a selected predetermined place on the baby product (surface of the baby product or auxiliary bottle feeding apparatus reception means or auxiliary bottle feeding apparatus reception space) placed at one position selected among left, right, front, between two legs, above the head of the baby seated in the bottle feeding posture, and the bottle fix section is mounted on the other end (horizontal arm),
2) a structure in which, under a condition where the auxiliary bottle feeding apparatus is developed into the bottle feeding position, both ends of the arm section which crosses in left and right direction the space placed in front of the body of the baby seated in the bottle feeding posture are respectively connected to the selected constituting element on the baby product placed at the left and right of the baby product, and the bottle fix section is mounted on a place placed at the front of the face of the baby from the rod which extends the arm section, and
3) a structure in which, under a condition where the auxiliary bottle feeding apparatus is developed into the bottle feeding position, one end of the arm section is connected, in the direction perpendicular to the surface to which the hips of the baby is seated, to the selected constituting element on the baby product placed on the front of the body of the baby seated in the bottle feeding posture, and the bottle fix section is mounted on the other end.

5. The auxiliary bottle feeding apparatus and the baby product to which the auxiliary bottle feeding apparatus is mounted, of claim 1 or 2, wherein, in case where the arm section is consisted of one rectangular member, the shape of the member is consisted of one structure selected among the resin molded part, wood molded part, metal wire curved molded part, jabara type member, and cobra type member.

6. The auxiliary bottle feeding apparatus and the baby product to which the auxiliary bottle feeding apparatus is mounted, of claim 1 or 2, wherein, in case where the arm section is consisted by the combination of two or more rectangular members, the combination method of the members is one of combination types such as a rotary retraction type, facing retraction type, slide retraction type, drawing in retraction type, and articulation rotary retraction type, or is the method into which two or more combination types are merged, or is the method in which one selected among the rotary retraction type, facing retraction type, slide retraction type, drawing in retraction type and articulation rotary retraction type and one selected among the jabara type and cobra type are merged.

7. The auxiliary bottle feeding apparatus and the baby product to which the auxiliary bottle feeding apparatus is mounted, of claim 1 or 2, wherein the bottle fix section further comprises one or more constituting elements selected among a bottle fix means fix stand, bottle fix means inclination adjustment means, bottle fix means fix shaft, bottle fix means horizontal rotation means, bottle fix means advance and retreat means, and bottle fix means height adjustment means.

8. The auxiliary bottle feeding apparatus and the baby product to which the auxiliary bottle feeding apparatus is mounted, of claim 1 or 2, wherein the arm section further comprises at least one constituting elements selected among an auxiliary bottle feeding apparatus vertical inclination adjustment means (=vertical arm length adjustment means), arm section retraction means, auxiliary bottle feeding apparatus height adjustment means, auxiliary bottle feeding apparatus horizontal rotation means, and injury prevention auxiliary arm.

9. The auxiliary bottle feeding apparatus and the baby product to which the auxiliary bottle feeding apparatus is mounted, of claim 1 or 2, wherein the baby product is one selected among a baby mattress, baby bed, car safety seat for baby, baby carriage, baby carrier, baby hip sack, baby waist sack, baby sofa, baby auxiliary chair, baby bottle feeding cushion, baby rocking bed, baby walker, pedestal for bottle feeding, and bottle feeding cradle.

10. The auxiliary bottle feeding apparatus and the baby product to which the auxiliary bottle feeding apparatus is mounted, of claim 9, wherein the baby product is constituted through a structure further including the auxiliary bottle feeding apparatus reception space which is a means for concealing and depositing the auxiliary bottle feeding apparatus mounted on the baby product in the baby product when the auxiliary bottle feeding apparatus is not in use, and which is constituted through a structure further comprising the auxiliary bottle feeding apparatus reception space which is a space recessed by extended to the deep part.

11. The auxiliary bottle feeding apparatus and the baby product to which the auxiliary bottle feeding apparatus is mounted, of claim 2 or 10, the auxiliary bottle feeding apparatus reception means or the auxiliary bottle feeding apparatus reception space is constituted by further comprising the closing means for closing the opening hole.

12. The auxiliary bottle feeding apparatus and the baby product to which the auxiliary bottle feeding apparatus is mounted, of claim 9, wherein the baby mattress is one selected among a mattress of single structure in which one auxiliary bottle feeding apparatus is mounted and a composite type mattress in which the mattress of the single structure is selected.

13. The auxiliary bottle feeding apparatus and the baby product to which the auxiliary bottle feeding apparatus is mounted, of claim 9, wherein the baby mattress further comprises at least one constituting elements selected among a back rest angle adjustment means, head fixing guard, body fixing guard, and mattress erection handle.

14. A baby carrier comprising:
a seating seat which is a resin expanded molded part or a resin expanded bead molded part for seating the hips of the baby;
a front safety guard which is a resin expanded molded part or a resin expanded bead molded part being a three dimensional face like member which wraps the stomach portion of the baby to prevent the forward falling of the baby seated on the seating seat and is erected at the edge of the front of the seating seat and is constituted by including two penetration holes to which two legs of the baby can be inserted; and
a shoulder traction string which is a traction means for combining the baby carrier to the mother who is a transporter.

15. The baby carrier of claim 14, further comprising at least one constituting elements selected among:
a side safety guard which is a three dimensional face like member which wraps both waist portions to prevent the side falling of the baby from the seating seat and is erected at both side edges of the seating seat;
a rear safety guard which is a three dimensional face like member wrapping back portion to prevent the rearward falling of the baby from the seating seat and is erected at back side edge of the seating seat; and
a vest type safety guard which includes one penetration hole penetrating the head of the baby and is a constituting element of the vest type which wraps the entire body of the baby, wherein the front end of the vest is connected to the front edge of the seating seat or to the upper edge of the front safety guard, and the back side end is connected to the rear edge of the seating seat, and
wherein the selected at least one constituting elements are constituted by the resin expanded molded part or the resin expanded bead molded part.

16. The baby carrier of claim 14, further comprising at least one constituting elements selected among:
a front and side safety guard which is the resin expanded molded part or the resin expanded bead molded part which is a three dimensional face like member concurrently wrapping the stomach and the waist of the baby to prevent the forward and side falling of the baby from the seating seat, and is erected at front and side edges of the seating seat as one member; and
a side and rear safety guard which is the resin expanded molded part or the resin expanded bead molded part which is a three dimensional face like member concurrently wrapping the waist and the back of the baby to prevent the side and rearward falling of the baby from the seating seat, and is erected at side and rear edges of the seating seat as one member.

17. The baby carrier of claim 14, 15 or 16, wherein the surface of the baby carrier is coated through one structure selected among a fabric coating, leather coating, and fiber flocking coating.

18. The baby carrier of claim 14, 15 or 16, further comprising the auxiliary bottle feeding apparatus.

19. A baby toy to which an auxiliary bottle feeding apparatus which comprises an auxiliary bottle feeding apparatus according to at least one structures selected among claims 1, 2, and 10 is mounted.

20. A baby toy to which an auxiliary bottle feeding apparatus for obstetrics and gynecology which comprises an auxiliary bottle feeding apparatus according to at least one structures selected among claims 1, 2, and 10 is mounted.
